(19) United States
(12) Patent Application Publication
(10) Pub. No.: US 2017/0214621 A1
(43) Pub. Date: Jul. 27, 2017

(54) NETWORK SWITCH, NETWORK CONTROL APPARATUS, AND NETWORK SYSTEM

(71) Applicant: FUJITSU LIMITED, Kawasaki-shi (JP)

(72) Inventors: Shinji Yamashita, Kawasaki (JP); TOSHIO SOUMIYA, Yokohama (JP)

(73) Assignee: FUJITSU LIMITED, Kawasaki-shi (JP)

(21) Appl. No.: 15/383,146

(22) Filed: Dec. 19, 2016

(30) Foreign Application Priority Data
Jan. 21, 2016 (JP) 2016-009936

(51) Int. Cl. H04L 12/801; H04L 12/721

(52) U.S. Cl. CPC H04L 47/12; H04L 45/70

(57) ABSTRACT

A network switch which is managed by one of plural controllers changes a processing scheme for an input signal of an unknown flow depending on a load of the controller managing the network switch.

### CROSS-REFERENCE TO RELATED APPLICATION

This application is based upon and claims the benefit of priority of the prior Japanese Patent Application No. 2016-009936, filed on Jan. 21, 2016, the entire contents of which are incorporated herein by reference.

### FIELD

The embodiments discussed herein relate to a network switch, a network control device, and a network system.

### BACKGROUND

In recent years, with a progress of virtualization of computing resources and an arrangement of a virtual computer on demand in a network, software defined networking (SDN) has attracted attention.

The SDN is an example of a technique available to set, change, or control a network on demand by software. In the SDN, a controller manages and controls plural network switches.

An OpenFlow protocol (OFP) is known as one strong candidate for a communication protocol available to realize the SDN. A controller can manage or control network switches by communicating with the network switches using the OFP.

A controller supporting the OFP may be referred to as an OF controller (OFC). A network switch supporting the OFP may be referred to as an OF switch (OF-SW).

Listing of Related Documents

Patent Document 1: JP 2011-170718 A

Patent Document 2: WO 2013/114490 A

When the number of OF switches being managed by the OFC increases with an increase in network scale, a load of the OFC may excessively increase, a stable operation of the OFC may be hindered, and a stable operation of a network may be hindered.

Therefore, distribution of loads in plural OFCs is attempted by forming the plural OFCs as a single logical controller. However, when message transmission of plural requests, inquiries, or the like from a specific OF switch to the OFC which manages the OF switch simultaneously occurs, the loads may be concentrated on a specific OFC to cause a bias of loads in the OFCs.

For example, when a signal of an unknown flow which is unregistered in a flow table is input, an OF switch inquires of an OFC managing the switch for an entry of the flow table using a packet-in message.

When signals of plural unknown flows are input to an OF switch, plural packet-in messages are transmitted from the OF switch to an OFC and thus a processing load for the packet-in messages in the OFC increases. As a result, a bias of loads may be caused in the OFCs.

### SUMMARY

According to an aspect, a network switch may include a load monitor and a processor. The load monitor may be configured to monitor a load of a first controller among a plurality of controllers. The processor may be configured to change, depending on the load monitored by the load monitor, a processing scheme for an input signal of an unknown flow for which the rule is unregistered.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a communication system according to an embodiment;

FIG. 2 is a diagram illustrating a processing example when a packet of an unknown flow is input to an OF-SW in the communication system illustrated in FIG. 1;

FIG. 3 is a diagram illustrating an example in which a load is biased to a specific OFC in the example illustrated in FIG. 2;

FIG. 4 is a block diagram illustrating an example of configurations of a distributed controller and an OF-SW according to an embodiment;

FIG. 5 is a diagram illustrating an example of a format of an OFP extension message which is used to transmit OFC load information according to an embodiment;

FIG. 6 is a diagram illustrating an example of a format of an OFP extension message which is used to transmit next-hop OF-SW information according to an embodiment;

FIG. 7 is a block diagram illustrating an example of a hardware configuration of an OF-SW according to an embodiment;

FIG. 8 is a flowchart illustrating an example of an operation of a distributed controller according to a first example;

FIG. 9 is a flowchart illustrating an example of an operation of a distributed controller according to the first example;

FIG. 10 is a diagram illustrating a processing example when a packet of a new flow is input to an OF-SW in the first example;

FIG. 11 is a diagram illustrating next-hop OF-SW information which is an example of new flow transfer destination determination information according to the first example;

FIG. 12 is a flowchart illustrating an example of an operation of an OF-SW according to the first example;

FIG. 13 is a diagram illustrating next-hop OF-SW information and master OFC information which are an example of new flow transfer destination determination information according to a second example;

FIG. 14 is a flowchart illustrating an example of an operation of an OF-SW according to the second example;

FIG. 15 is a diagram illustrating an example of a configuration and an operation of a communication system according to a third example;

FIG. 16 is a diagram illustrating next-hop OF-SW information, master OFC information, and OFC load information which are an example of new flow transfer destination determination information according to the third example;

FIG. 17 is a flowchart illustrating an example of an operation of an OF-SW according to the third example;

FIG. 18 is a diagram illustrating next-hop OF-SW information, master OFC information, and OFC load information which are an example of new flow transfer destination determination information according to a fourth example;

FIG. 19 is a flowchart illustrating an example of an operation of an OF-SW according to the fourth example;

FIG. 20 is a diagram illustrating an example of a configuration and an operation of a communication system according to a fifth example;

FIG. 21 is a flowchart illustrating an example of an operation of an OF-SW according to the fifth example;

FIG. 22 is a flowchart illustrating an example of time-to-live (TTL) processing illustrated in FIG. 21;

FIG. 23 is a diagram illustrating an example of a configuration and an operation of a communication system according to a sixth example;

FIG. 24 is a diagram illustrating an example of a configuration and an operation of the communication system according to the sixth example;

FIG. 25 is a diagram illustrating next-hop OF-SW information, master OFC information, and OFC load information which are an example of new flow transfer destination determination information according to the sixth example; and

FIG. 26 is a flowchart illustrating an example of an operation of an OF-SW according to the sixth example.

### DESCRIPTION OF EMBODIMENTS

Hereinafter, embodiments will be described with reference to the accompanying drawings. The embodiments described below are exemplary and are not intended to exclude application of various modifications or techniques which are not described below. Various exemplary aspects which are described below may be embodied in appropriate combination. In the drawings which are used to describe the embodiments, parts referenced by the same reference signs denote identical or similar parts unless particularly mentioned different.

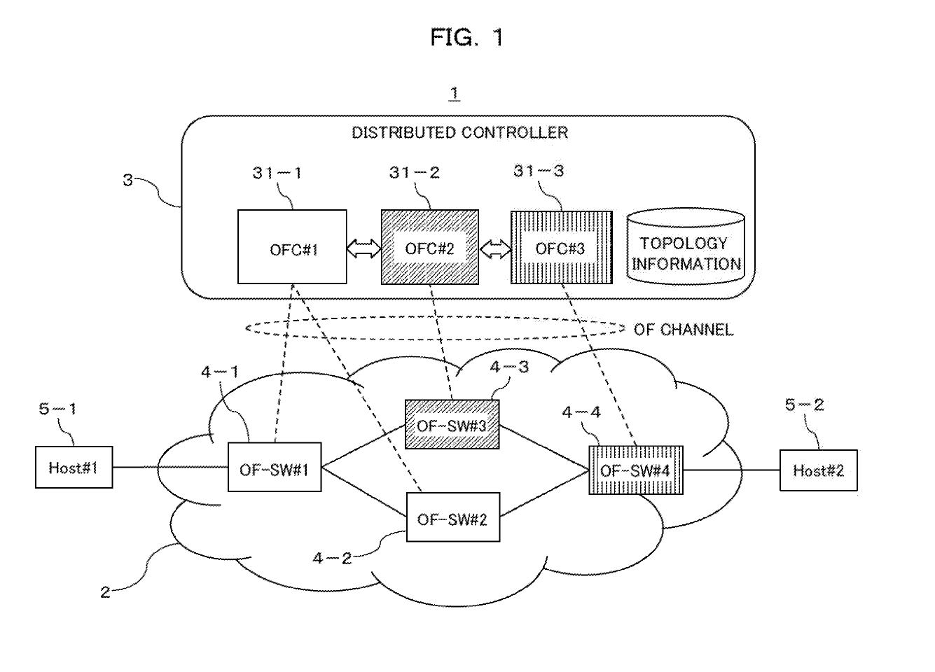

FIG. 1 is a diagram illustrating an example of a configuration of a communication system according to an embodiment. A “communication system” may be referred to as a “network system.” As illustrated in FIG. 1, for example, the communication system 1 may include a network 2 and a controller 3.

For example, the network 2 may be a network that supports SDN, and the controller 3 may be a network controller that supports an OpenFlow protocol (OFP).

The network 2 may include plural network devices 4-1 to 4-N (where N is an integer equal to or greater than 2) as an example of a network element (NE). FIG. 1 illustrates an example of N=4.

The network device 4-k (where k is any one of 1 to N) may be a network switch that supports the OFP. The “network switch” that supports the OFP may be referred to as an “OF switch (OF-SW).”

When the “OF-SWs 4-k” does not have to be distinguished, the “OF-SWs 4-k” may be abbreviated to “OF-SWs 4.” The network 2 constituted by the OF-SWs 4 may be referred to as an “OF network 2.”

For example, the controller 3 is available to concentrically control the plural OF-SWs 4 constituting the OF network 2. For example, the controller 3 may be communicably connected to the OF-SWs 4 to control communication between the OF-SWs 4.

A transmission control protocol (TCP) or a transport layer security (TLS) may be applied to connection between the controller 3 and the OF-SWs 4. In other words, “sessions” or “channels” of TCP or TLS may be set up and established between the controller 3 and the OF-SWs 4. The “sessions” or “channels” may be understood as an example of logical communication paths.

An OFP-based control signal (which may be referred to as a “message”) may be transmitted or received through the “sessions” or “channels” in a control plane (CP). The “sessions” or “channels” through which the OFP-based message is transmitted or received may be referred to as “OF sessions” or “OF channels” for descriptive purposes.

For example, communication between the OF-SWs 4 is a transfer of data in a data plane and may be referred to as a “data flow” or simply a “flow.” Data or a signal which is transferred through the “flow” may be packet data. The packet data may be simply abbreviated to a “packet.”

A “flow” may be understood as a set of data which is identified by an arbitrary combination of header information (such as an Ethernet (registered trademark) address, a VLAN tag, an IP address, and a TCP/UDP port number) of packets.

“VLAN” is an abbreviation of “virtual local area network.” “IP” is an abbreviation of “Internet protocol.” “TCP” is an abbreviation of “transmission control protocol” and “UDP” is an abbreviation of “user datagram protocol.”

For example, as illustrated in FIG. 1, it is assumed that a host 5-1 (host #1) is connected to the OF-SW 4-1, a host 5-2 (host #2) is connected to the OF-SW 4-4, and the hosts 5-1 and 5-2 communicate with each other.

The “host” is an example of a communication device available to transmit and receive data such as a packet. The “host” may be connected to any of the OF-SWs 4 that constitute the OF network 2. A plurality of “hosts” may be connected to a single OF-SW 4.

In the example illustrated in FIG. 1, a flow between the hosts 5-1 and 5-2 may be transferred between the OF-SWs 4 through a path routed through the OF-SWs 4-1, 4-3, and 4-4, or a path routed through the OF-SWs 4-1, 4-2, and 4-4.

A path of a flow in the OF network 2 may be referred to as a “data path.” The “data path” may be identified based on “data path IDs (DPID)” assigned to the OF-SWs 4.

The controller 3 may have centralized manage and control over flows between the OF-SWs 4. For example, the controller 3 may have centralized manage and control over entries of flow tables stored in the OF-SWs 4.

In order to control flows between the OF-SWs 4, the controller 3 may detect topology information of the OF network 2. The topology information is an example of information enabling identification of a connection relation between the OF-SWs 4 in the OF network 2. The controller 3 may perform path calculation for the OF network 2 based on the topology information.

For example, the controller 3 can realize advanced traffic engineering such as path control for saving power of the OF network 2 as a whole (which may be abbreviated to “power-saving path control”) based on the topology information of the OF network 2.

A unit of control by the controller 3 is referred to as a “flow” and communication control not depending on layers can be performed by expressing a flow of data by a “flow” in any combination of networks having an existing layer structure.

An “OpenFlow (OF)” is an example of a technique of processing a specific protocol such as an OFP to control the network. On the other hand, “SDN” is an example of a technique of extending the concept of the OF to existing network protocols to enable control in an NE which does not support the OFP.

As illustrated in FIG. 1, a “distributed controller” in which a “cluster” may be constituted by plural OFCs 31-1 to 31-n (where n is an integer equal to or greater than 2) and which operates logically as a single controller may be applied to the controller 3.

The distributed controller 3 is an example of a network control apparatus. All of the OFCs 31-1 to 31-n are an example of controllers supporting the OFP.

As a non-restrictive example, the case of n=3, that is, an example in which a single distributed controller 3 is constituted by a “cluster” of three OFCs 31-1 to 31-3, is illustrated in FIG. 1. The distributed controller 3 may be referred to as a “controller cluster 3.” The controller cluster 3 is recognized as a single logical controller by the switches 4.

The individual OFCs 31-i (where i is any one of 1 to n) constituting the controller cluster 3 may be referred to as “element controllers” or “controller components” for descriptive purposes. For example, a computer such as a server may correspond to the OFC 31-i. When the OFCs 31-1 to 31-n do not have to be distinguished, the OFCs 31-1 to 31-n may be simply abbreviated to “OFCs 31.”

For example, a plurality of OFCs 31-i is available to communicate with each other and to share management or control of plural OF-SWs 4. Accordingly, the communication system 1 illustrated in FIG. 1 is an example of a system that distributedly manages or controls a plurality of switches 4 using a plurality of OFCs 31.

In FIG. 1, for example, the OFC 31-1 may be responsible for management of the OF-SWs 4-1 and 4-2. For example, the OFC 31-2 may be responsible for management of OF-SW 4-3. For example, the OFC 31-3 may be responsible for management of the OF-SW 4-4.

The OFC 31-i may be referred to as a “master OFC 31-i” in the OF-SW 4 which is managed thereby. For example, in the example illustrated in FIG. 1, the OFC 31-1 corresponds to a master OFC of the OF-SWs 4-1 and 4-2. The OFC 31-2 corresponds to a master OFC of the OF-SW 4-3. The OFC 31-3 corresponds to a master OFC of the OF-SW 4-4.

For example, each OF-SW 4 can form an OF channel (see the dotted line in FIG. 1) between the OF-SW 4 and the master OFC 31 in a control plane and communicate with the master OFC 31 via the OF channel.

By applying a “distributed controller” constituted as a “controller cluster” to the network controller 3 as described above, it is possible to improve scalability or failure resistance of the network controller 3.

Here, loads may be concentrated or biased on a specific OFC 31 among plural OFCs 31 that constitute the network controller 3. The load of the OFC 31 may be determined based on utilization of a processor such as a central processing unit (CPU) responsible for operation of the OFC 31 or utilization of a memory which is accessed by the OFC 31 with its operation.

By causing the distributed controller 3 to perform load-distributing control to reduce a bias of loads to the plurality of OFCs 31, it is possible to stably operate the distributed controller 3.

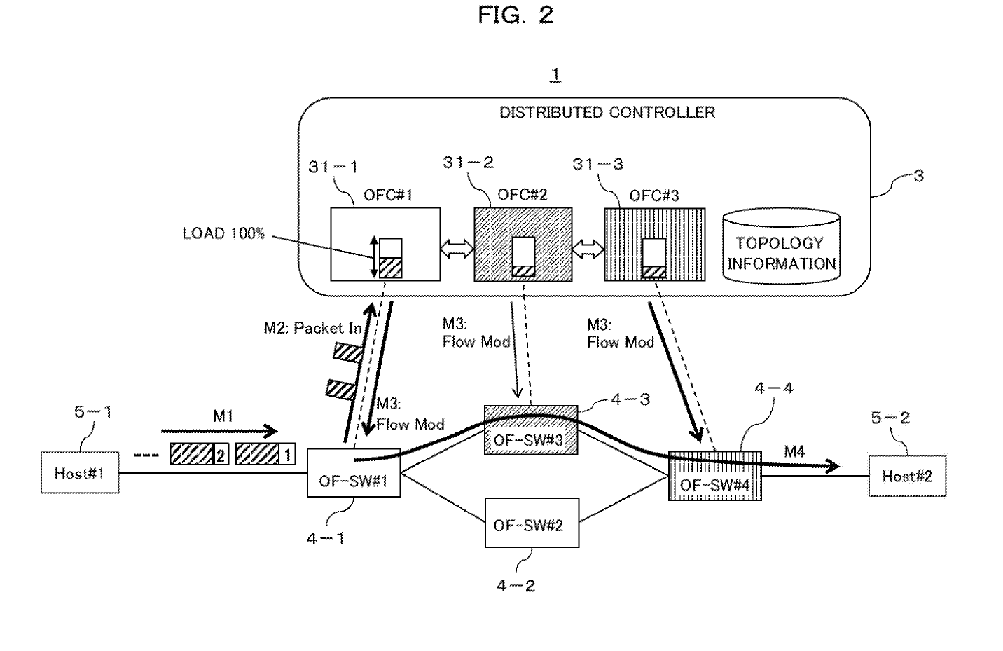

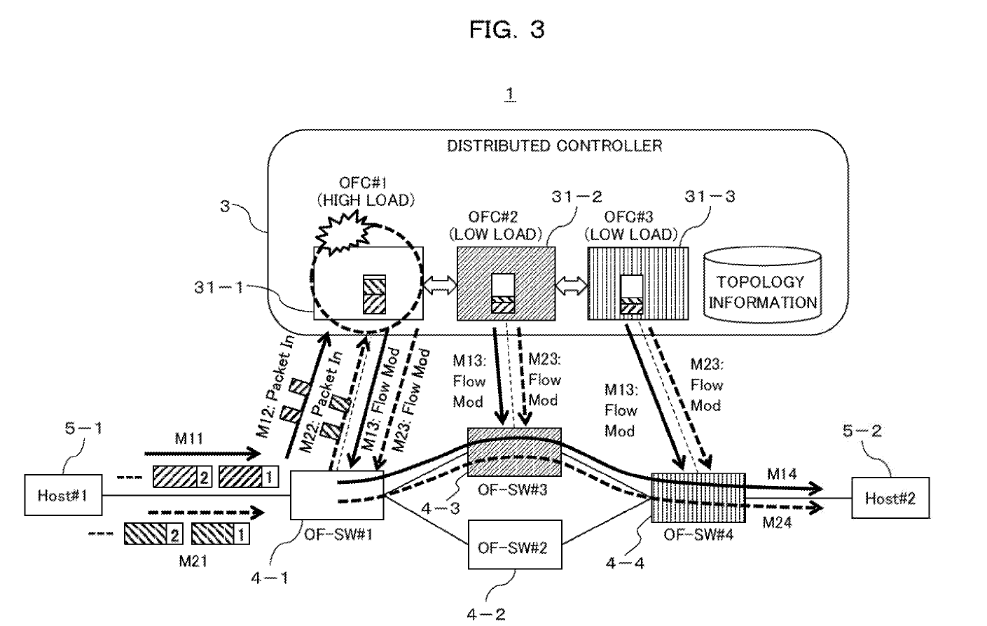

An example in which loads are biased to a specific OFC 31-i (for example, the OFC 31-1) in the distributed controller 3 will be described below with reference to FIGS. 2 and 3.

For example, it is assumed that communication between the hosts 5-1 and 5-2 is started. For example, when the host 5-1 transmits a packet to the host 5-2 (see reference sign M1 in FIG. 2), the packet is input to the OF-SW 4-1.

Here, each OF-SW 4 has a “flow table.” In the “flow table,” a “rule” and an “action” correlated with the “rule” may be registered in the unit of “flow.”

When a packet is input to an OF-SW 4, the OF-SW 4 executes an “action” which matches the “rule” registered in the “flow table” with reference to the “flow table.”

When the “rule” corresponding to an input packet is not registered in the “flow table,” that is, when a packet of an unknown flow is input to the OF-SW 4, the OF-SW 4 may inquire of the distributed controller 3 for the “rule.” The “unknown flow” in the OF-SW 4 may be referred to as a “new flow.”

A “packet-in message” (which may be hereinafter abbreviated to a “packet-in”) of the OFP may be used for the “inquiry.” The packet-in may include a packet of a new flow input to the OF-SW 4.

For example, when the “rule” corresponding to the packet input from the host 5-1 to the OF-SW 4-1 is not registered in the “flow table” of the OF-SW 4-1, the OF-SW 4-1 transmits a packet-in to the distributed controller 3 (see reference sign M2 in FIG. 2).

The packet-in is received, for example, by the master OFC 31-1 of the OF-SW 4-1. The master OFC 31-1 calculates a path of a flow based on the packet included in the received packet-in and sets the path of the flow for the OF-SW 4 which is located in the path determined based on the calculation result.

When an OF-SW 4 being managed by another OFC 31-2 or 31-3 is present in the determined path, the OFC 31-1 may request another master OFC 31-2 or 31-3 for the path calculation and the setting of the path of the flow by communication between the OFCs.

In the example illustrated in FIG. 2, with reception of the packet-in by the master OFC 31-1 as a trigger, it is assumed that the path routed through the OF-SWs 4-1, 4-3, and 4-4 is determined as a target of which the flow path will be set by the path calculation.

Accordingly, the master OFCs 31-1, 31-2, and 31-3 managing the OF-SWs perform the setting of the flow path for the OF-SWs 4-1, 4-3, and 4-4. A flow modification (FlowMod) message may be used to set the flow path (see reference sign M3 in FIG. 2).

When a flow modification message is received from the master OFC 31 as a management source, the OF-SWs 4-1, 4-3, and 4-4 set and register the “rule” set in the message in the “flow tables.”

Thereafter, the packet transmitted from the host 5-1 to the host 5-2 is transferred to the host 5-2 via the path routed through the OF-SWs 4-1, 4-3, and 4-4 (see reference sign M4 in FIG. 2).

In the “rule” registered in the “flow table,” for example, match rules may be described and “actions” may be designated for the match rules. The “actions” are not limited to transfer of an input packet, but other operations may be designated. For example, an operation of rewriting a specific header field of an input packet may be designated as an “action.”

In this way, when a packet-in is received from any one OF-SW 4, the distributed controller 3 calculates a flow path and sets the flow path for the OF-SW 4 located in the path determined by the path calculation using the corresponding OFC 31.

Accordingly, paying attention to the OFC 31-1 having received a packet-in issued from the OF-SW 4-1, a processing load of the packet-in, a path calculation load, and a processing load for issuing a flow modification message are generated in the OFC 31-1.

On the other hand, a path calculation load and a processing load for issuing a flow modification message are generated in the OFCs 31-2 and 31-3. Since the OFCs 31-2 and 31-3 do not process a packet-in transmitted from the OF-SW 4-1 other than the OF-SWs to be managed, the OFCs 31-2 and 31-3 are considered as having a processing load lower than that of the OFC 31-1.

As illustrated in FIG. 3, it is assumed that packets of plural (two in the example illustrated in FIG. 3) new flows are input to the OF-SW 4-1 from the host 5-1 (see reference signs M11 and M21). It is assumed that the path routed through the OF-SWs 4-1, 4-3, and 4-4 is determined as a path setting target for one new flow by the path calculation.

For example, in FIG. 3, a solid arrow referenced by reference sign M14 indicates that a packet of a new first flow is transferred through the path determined for the packet of the first flow by the path calculation. A dotted arrow referenced by reference sign M24 indicates that a packet of a new second flow is transferred through the path determined for the packet of the second flow by the path calculation.

In this case, a processing load of the packet-in, a path calculation load, and a processing load for issuing a flow modification message for each of plural packet-ins are generated in the master OFC 31-1 of the OF-SW 4-1.

In FIG. 3, reference sign M12 indicates transmission of a packet-in for the packet of the first flow, and reference sign M13 indicates transmission of a flow modification message for the packet of the first flow.

Reference sign M22 indicates transmission of a packet-in for the packet of the second flow, and reference sign M23 indicates transmission of a flow modification message for the packet of the second flow. “Mxy (where x and y are positive integers) may be understood to indicate a y-th process for an x-th flow (which is true of the following description).

On the other hand, based on the request from the OFC 31-1 having received the plural packet-ins (see reference signs M12 and M22), a path calculation load and a processing load for issuing a flow modification message are generated in the other OFCs 31-2 and 31-3 (see reference signs M13 and M23).

The OFCs 31-2 and 31-3 do not have the processing load of a packet-in generated therein and thus has a lower load than that of the OFC 31-1, and the loads are biased to the OFC 31-1.

In this way, when plural packet-ins are transmitted from the OF-SW 4 to which packets of plural new flows have been input to the master OFC 31, loads are likely to be concentrated on the master OFC 31. The master OFC 31 on which the loads have been concentrated may serve as a bottleneck in processing performance of the distributed controller 3.

Therefore, in this embodiment, when a packet of a new flow is input to an OF-SW 4, the OF-SW 4 controls whether to transmit a packet-in depending on a load condition of the master OFC 31 as a management source.

For example, the OF switch to which a packet of a new flow has been input checks a load of the master OFC 31 and may transmit a packet-in to the master OFC 31 when the load is equal to or lower than a threshold value.

When the load is greater than the threshold value, the OF-SW 4 does not need to transmit a packet-in to the master OFC 31. Alternatively, the OF-SW 4 may transfer an input packet of a new flow to a next-hop (which may be referred to as “neighbor”) OF-SW 4.

The packet-in for the packet of the new flow can be issued from the next-hop OF-SW 4 having received the packet. For example, the “next-hop OF-SW 4” corresponds to another OF-SW 4 communicably connected to the output port of the noticed OF-SW 4.

When the load of the master OFC 31 managing the next-hop OF-SW 4 to which the packet of the new flow has been transmitted is higher than the threshold value, the OF-SW 4 having received the packet does not issue a packet-in but may additionally transfer the input packet to the next-hop OF-SW 4.

In this way, since the OF-SW 4 suppresses transmission of the packet-in for the new flow depending on the load condition of the master OFC 31 and transferring the packet to the next-hop OF-SW 4, it is possible to achieve load distribution by reducing a bias of loads to the OFCs 31.

The distributed controller 3 may transmit (which may be referred to as “notify”) information indicating loads of the master OFCs 31 (which may be abbreviated to “load information”) to the OF-SWs 4 such that the OF-SWs 4 can check the loads of the master OFCs 31.

The distributed controller 3 may notify information of other OF-SW(s) 4 communicably connected to the output port of each OF-SW 4 to the OF-SWs 4 to make each OF-SW 4 available to recognize the next-hop OF-SWs 4.

The information may be referred to as “next-hop OF-SW information” for descriptive purposes. For example, the next-hop OF-SW information can be generated based on topology information by the distributed controller 3. The topology information may include information indicating connection relations between the OF-SWs 4 and the hosts.

The information indicating the connection relations between the OF-SWs 4 and the host may be set, for example, by a network administrator. The next-hop OF-SW information does not need to include the information indicating the connection relations between the OF-SWs 4 and the host. In other words, an input packet of an unknown flow does not need to be transferred from the OF-SWs 4 to the host. Accordingly, the host is excluded from transfer destination candidates of an input packet of an unknown flow from the OF-SWs 4.

The next-hop OF-SW information may be generated for each output port of the OF-SWs 4 or may include identification information of the OF-SWs 4 connected to the output port. For example, the identification information of the OF-SWs 4 may be aforementioned data path IDs (DPIDs).

(Examples of Configurations of Distributed Controller and OF Switch)

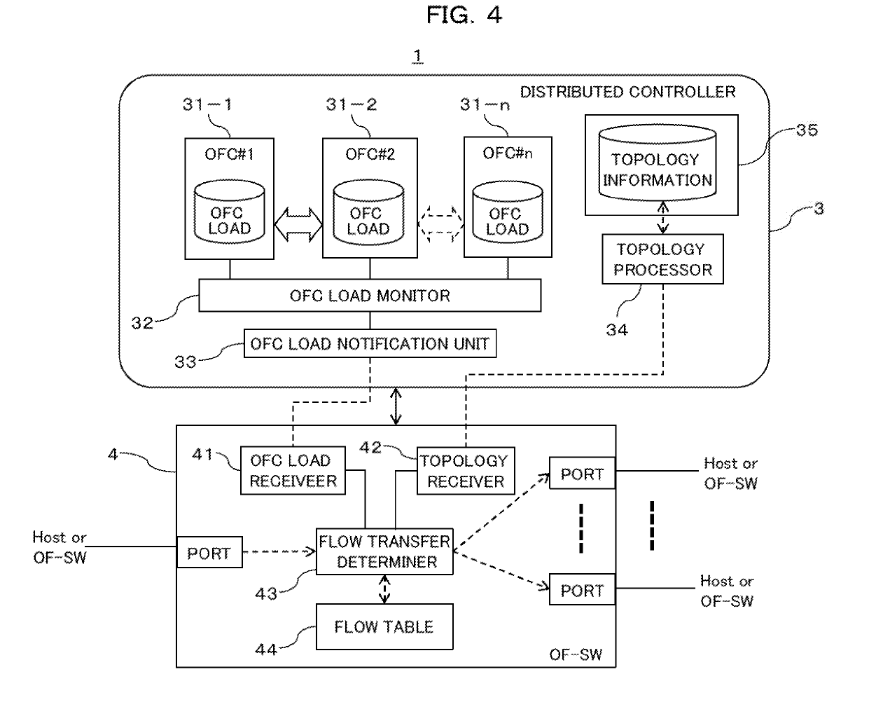

FIG. 4 illustrates an example of functional configurations of a distributed controller 3 and an OF-SW 4 according to an embodiment.

As illustrated in FIG. 4, the distributed controller 3 may include, for example, the aforementioned plural OFCs 31-1 to 31-n, an OFC load monitor 32, an OFC load notification unit 33, a topology processor 34, and a storage unit 35.

On the other hand, the OF-SW 4 may include, for example, an OFC load receiver 41, a topology receiver 42, a flow transfer determiner 43, and a flow table 44.

In the distributed controller 3, the OFC load monitor 32 monitors, for example, loads of the OFCs 31. The load of each OFC 31 may be expressed by one or both of utilization of a processor such as a central processing unit (CPU) and utilization of a memory which is accessed by the OFC 31 with its operation. The monitoring result of the OFC load monitor 32 may be referred to as “OFC load information.”

The OFC load notification unit 33 notifies the OFC load information to any one of the OF-SWs 4 being managed by the distributed controller 3. The notification of the OFC load information may be performed periodically or non-periodically.

When the OFC load information is notified periodically, a notification cycle may be set to a period long enough not to affect the load of the OFC 31. In an example of the non-periodical notification of the OFC load information, the OFC load information is notified to an OF-SW 4 as a request source in response to a request from the OF-SW 4.

The notification of the OFC load information may be performed by the OFP using a message to which is extended from an OFP message (which may be referred to as an “OFP extension message” for descriptive purposes) or may be performed using a message of a protocol other than the OFP.

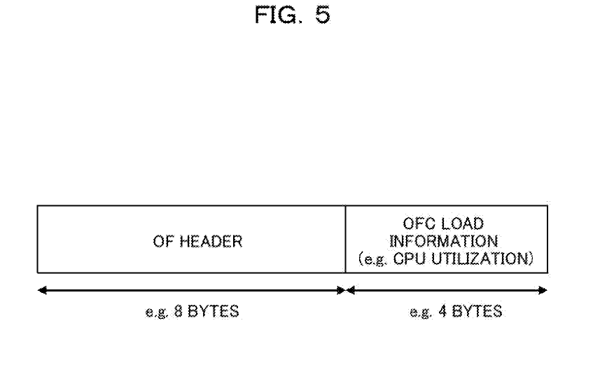

FIG. 5 illustrates an example of a format of the OFP extension message which is used for the notification of the OFC load information as a non-restrictive example. The OFP extension message illustrated in FIG. 5 includes, for example, an OF header field of 8 bytes and a payload field of 4 bites.

Address information of a destination OF-SW 4 of the OFC load information may be set in the OF header field or the OFC load information may be set in the payload field.

The OFC load information which is transmitted to one OF-SW 4 is not limited to load information of a master OFC 31 which manages the OF-SW 4 but may include load information of another master OFC 31 other than the master OFC 31.

For example, not limited to the load information of a first master OFC 31 which manages a first OF-SW 4, load information of a second master OFC 31 which manages a second OF-SW located in a next hop of the first OF-SW 4 may be transmitted to the first OF-SW 4.

For example, the topology processor 34 may extract information (for example, DPID) of next-hop OF-SWs 4 connected to the output ports of the OF-SWs 4 based on topology information of the OF network 2 and notify the extracted information to the OF-SWs 4.

Similarly to the notification of the OFC load information, for example, the notification of the next-hop OF-SW information may be performed by the OFP using the OFP extension message or may be performed using a message of a protocol other than the OFP.

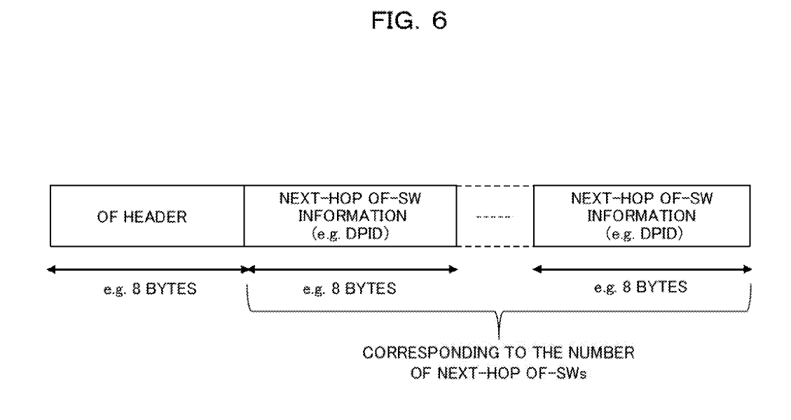

FIG. 6 illustrates an example of a format of an OFP extension message which is used for the notification of the next-hop OF-SW information as a non-restrictive example. The OFP extension message illustrated in FIG. 6 includes, for example, an OF header field of 8 bytes and a payload field.

Address information of a destination OF-SW 4 of the next-hop OF-SW information may be set in the OF header field or the next-hop OF-SW information corresponding to the number of next-hop OF-SWs 4 may be set in the payload field. The next-hop OF-SW information for each OF-SW may be expressed, for example, by information of 8 bytes.

The topology processor 34 may notify information of the master OFC 31 (which may be abbreviated to “master OFC information” for descriptive purposes) which manages the next-hop OF-SW 4 to the OF-SWs 4. For example, information available to identify an OFC 31 can be used as the master OFC information.

The notification of one or both of the next-hop OF-SW information and the master OFC information may be performed, for example, only when the topology information of the OF network 2 is changed. By limiting the notification to a case in which the topology information is changed, it is possible to suppress an increase in the processing load of the topology processor 34.

The storage unit 35 stores, for example, the topology information of the OF network 2. For example, a hard disk drive (HDD) or a solid state drive (SSD) may be applied as the storage unit 35.

Meanwhile, in each OF-SW 4, the OFC load receiver 41 communicates with, for example, the OFC load notification unit 33 of the distributed controller 3 and receives and acquires the OFC load information of the master OFC 31 which manages the OF switch 4.

The OFC load receiver 41 may communicate with the OFC load notification unit 33 and receive and acquire the OFC load information of another OFC 31 which manages a next-hop OF-SW 4 in addition to the OFC load information of the master OFC 31 for the corresponding SW 4.

The master OFC 31 for the corresponding SW 4 is an example of a first controller and the master OFC 31 of another OF-SW 4 connected to the corresponding SW 4 is an example of a second controller. When plural other OF-SWs 4 connected to the corresponding SW 4 are present, all of the master OFCs 31 manage the OF-SWs 4 may be understood to correspond to the second controller.

For example, it may be understood that the master OFC 31-1 of the OF-SW 4-1 corresponds to the first controller and the master OFCs 31-3 and 31-2 of the another OF-SWs 4-2 and 4-3 connected to the OF-SW 4-1 correspond to the second controller.

The OFC load receiver 41 may monitor of the load of the first controller by acquiring the load information of the first controller and may monitor the load of the second controller by acquiring the load information of the second controller. Accordingly, the OFC load receiver 41 is an example of a “load monitor” which monitors the load of the first controller or the loads of the first and second controllers.

The topology receiver 42 communicates with, for example, the topology processor 34 of the distributed controller 3 and receives and acquires the next-hop OF-SW information (the next-hop OF-SW information and the master OFC information of the next-hop OF-SW 4 in some cases).

The flow transfer determiner 43 determines whether to transfer an input packet of a new flow to the next-hop OF-SW 4, for example, based on the OFC load information and the next-hop OF-SW information. When plural next-hop OF-SWs 4 are present as transfer destination candidates, the flow transfer determiner 43 may determine a transfer destination OF-SW 4 (that is, an output port to which the input packet is to be transferred) based on the OFC load information of the master OFCs 31 of the next-hop OF-SWs 4.

The flow transfer determiner 43, or the flow transfer determiner 43 and the topology receiver 42 are an example of a processor that changes a processing scheme for the input packet of the new flow depending on the load of the master OFC 31. The “changing of the processing scheme” may be understood to be “changing of an action.”

An example of the control of changing the processing scheme may be to control whether to transmit a packet-in to a master OFC 31 or whether to transmit the input packet of the new flow to a next-hop OF-SW 4 without transferring the packet-in depending on the load of the master OFC 31.

(Example of Hardware Configuration of OF-SW)

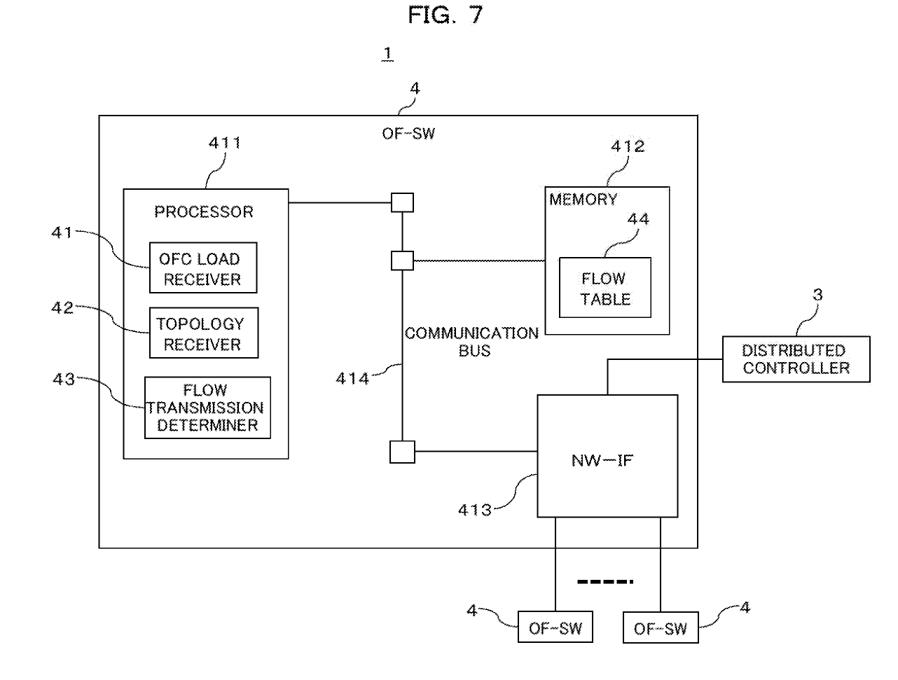

An example of a hardware configuration of an OF-SW 4 will be described below with reference to FIG. 7. As illustrated in FIG. 7, the OF-SW 4 may include, for example, a processor 411, a memory 412, and a network interface (NW-IF) 413. The processor 411, the memory 412, and the NW-IF 413 may be communicably connected to each other via a communication bus 414.

The processor 411 is an example of processor that controls the whole operation of the OF-SW 4. For example, an arithmetic processing unit or an arithmetic processing circuit having arithmetic processing capability such as a CPU or a digital signal processor (DSP) may be applied as the processor 411.

The processor 411 realizes the function of the OF-SW 4, for example, by appropriately reading and executing a program or data stored in the memory 412. The “program” may be referred to as “software” or “application.”

By operation of the processor 411, the functions of the OFC load receiver 41, the topology receiver 42, and the flow transfer determiner 43 which are illustrated in FIG. 4 may be realized.

The memory 412 stores, for example, the aforementioned program or data. The memory 412 is an example of a storage device or a storage medium, and a random access memory (RAM), a flash memory, a solid state drive (SSD), a hard disk drive (HDD), or the like may be applied as the memory 412.

The data stored in the memory 412 may include the OFC load information, the next-hop OF-SW information, and the master OFC information of the next-hop OF-SW 4 which are acquired from the distributed controller 3 and the flow table 44 illustrated in FIG. 4.

The flow table 44 is an example of path information which is used for the flow transfer determiner 43 to determine a transfer of a flow. For example, as described above, the path information may be calculated by the distributed controller 3 (for example, the master OFC 31) and set in the OF switch 4.

The NW-IF 413 is, for example, an interface that enables communication with the distributed controller 3 and another OF-SW 4 and can transmit and receive the aforementioned packet-in or the aforementioned flow modification message.

For example, paying attention to a receiving process, the NW-IF 413 is an example of a receiver that receives a message transmitted from the distributed controller 3 to the OF-SW 4 and is also an example of a receiver that receives a message or a packet transmitted from another OF-SW 4.

Paying attention to a transmitting process, the NW-IF 413 is an example of a transmitter that transmits a packet-in to the distributed controller 3 and is also an example of a transfer unit that transfers a packet to another OF-SW 4 depending on the determination result of the flow transfer determiner 43.

(Example of Operation)

Some examples of the operation of the communication system 1 according to the embodiment will be described below.

### First Example

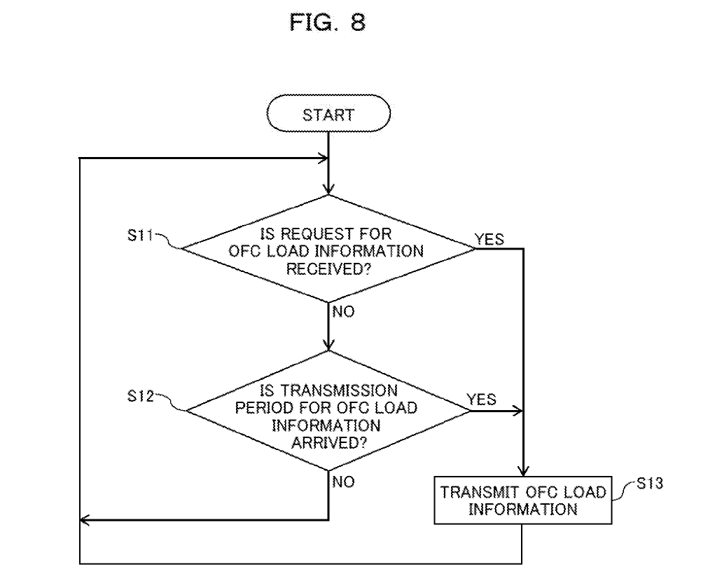

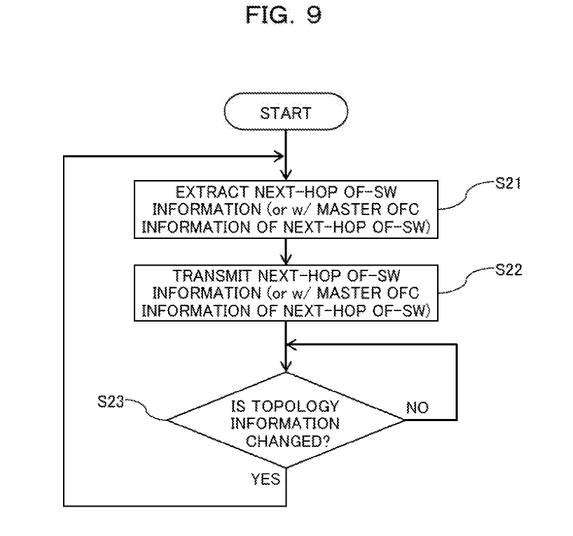

FIGS. 8 and 9 are flowcharts illustrating examples of the operation of the distributed controller 3. FIG. 8 illustrates a processing example relevant to transmission of the OFC load information and FIG. 9 illustrates a processing example relevant to transmission of the next-hop OF-SW information.

(Processing Example of Transmission of OFC Load Information)

As illustrated in FIG. 8, the distributed controller 3 may monitor whether a request for the OFC load information is received from any one of the OF-SWs 4 to be managed (Process S11). The monitoring may be performed, for example, by the OFC load notification unit 33 (see FIG. 4).

When a request for the OFC load information is received (YES in Process S11), the OFC load notification unit 33 may transmit the OFC load information acquired by the OFC load monitor 32 to the OF-SW 4 as a request source (Process S13).

When a request for the OFC load information is not received (NO in Process S11), the OFC load notification unit 33 may check whether a transmission period of the OFC load information arrives (Process S12). The transmission period of the OFC load information may be set in advance by the distributed controller 3 or may be monitored, for example, by a timer that counts a set period in the OFC load notification unit 33.

When the transmission period arrives (YES in Process S12), the OFC load notification unit 33 may transmit the OFC load information acquired by the OFC load monitor 32 to the OF-SWs 4 being managed by the distributed controller 3.

When the transmission period does not arrive (NO in Process S12), the OFC load notification unit 33 may perform the aforementioned process S11.

(Processing Example of Transmission of Next-Hop OF-SW)

The distributed controller 3 may performed the process flow illustrated in FIG. 9 before, after, or in parallel with the processing example relevant to the aforementioned transmission of the OFC load information.

As illustrated in FIG. 9, the distributed controller 3 may extract the next-hop OF-SW information of the OF-SWs 4 under management from the topology information stored in the storage unit 35, for example, by the use of the topology processor 34 (see FIG. 4) (Process S21).

At this time, the topology processor 34 may extract the master OFC information of the next-hop OF-SW 4 from information (which may be referred to as “OFC-SW correspondence information” for descriptive purposes) indicating what OFCs 31 manage the OF-SWs 4. The OFC-SW correspondence information may be stored, for example, in the storage unit 35.

When the next-hop OF-SW information is extracted, the topology processor 34 may transmit the extracted next-hop OF-SW information to the OF-SWs 4 being managed by the distributed controller 3 (Process S22). When the master OFC information of the next-hop OF-SW 4 is extracted, the topology processor 34 may transmit the master OFC information along with the next-hop OF-SW information to the OF-SWs 4.

Thereafter, the topology processor 34 may monitor whether the topology information is changed (Process S23). When the topology information is changed (YES in Process S23), the topology processor 34 may perform Processes S21 and S22 again. When the topology information is not changed (NO in Process S23), the topology processor 34 may be monitored continually.

Through the process flows illustrated in FIGS. 8 and 9, each OF-SW 4 can acquire the OFC load information and the next-hop OF-SW information (or the master OFC information of the next-hop OF-SW 4 in addition) from the distributed controller 3 through the use of the OFC load receiver 41 and the topology receiver 42.

Accordingly, when a packet of a new flow is input, each OF-SW 4 can suppress transmission of a packet-in to the master OFC 31 thereof or transfer the input packet to the next-hop OF-SW 4 depending on the load of the master OFC 31.

(Processing Example of Packet of New Flow)

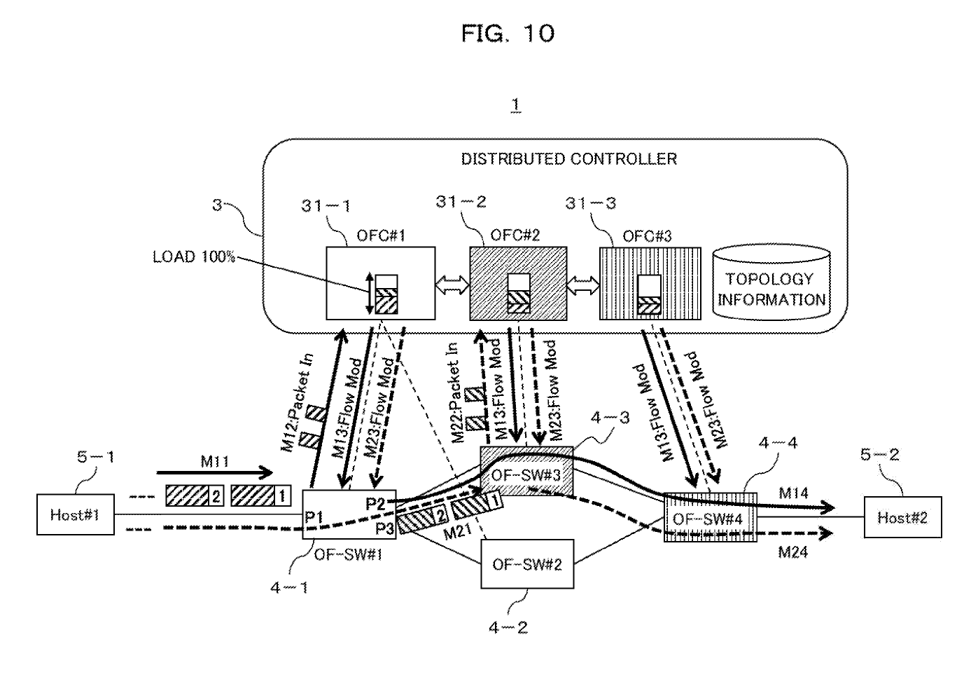

A processing example when a packet of a new flow is input to an OF-SW 4 will be described below with reference to FIGS. 10 to 12.

FIG. 10 illustrates a case in which packets of plural (two in the example illustrated in FIG. 10) new flows are input to the OF-SW 4-1 from the host 5-1, similarly to the case illustrated in FIG. 3.

It is assumed that the path routed through the OF-SWs 4-1, 4-3, and 4-4 (see the solid arrow M14 and the dotted arrow M24) is set as a path setting target for any flow by the path calculation.

In the example illustrated in FIG. 10, reference signs P1 to P3 referencing the OF-SW 4-1 denote port numbers (which may be referred to as “port identification information”) of the OF-SW 4-1. The “port” of the OF-SW 4 may be a physical port or a logical port. For example, reference sign P1 denotes an input port of the OF-SW 4-1 and reference signs P2 and P3 denote output ports of the OF-SW 4-1.

In the example illustrated in FIG. 10, the input port P1 of the OF-SW 4-1 is connected to the host 5-1, one output port P2 of the OF-SW 4-1 is connected to the OF-SW 4-3, and the other output port P3 of the OF-SW 4-1 is connected to the OF-SW 4-2.

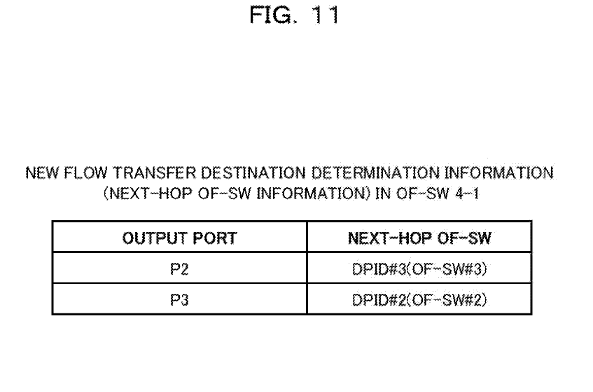

FIG. 11 is a diagram illustrating an example of the next-hop OF-SW information which is acquired from the distributed controller 3 by the OF-SW 4-1. The information illustrated in FIG. 11 is used to determine a transfer destination of an input packet of a new flow and thus may be referred to as “new flow transfer destination determination information” for descriptive purposes.

As illustrated in FIG. 11, the new flow transfer destination determination information may include identification information (for example, DPID) of the OF-SWs 4-3 and 4-2 connected to the output ports P2 and P3 of the OF-SW 4-1. In FIG. 11, “DPID#2” denotes the identification information of the OF-SW 4-2 and “DPID#3” denotes the identification information of the OF-SW 4-3.

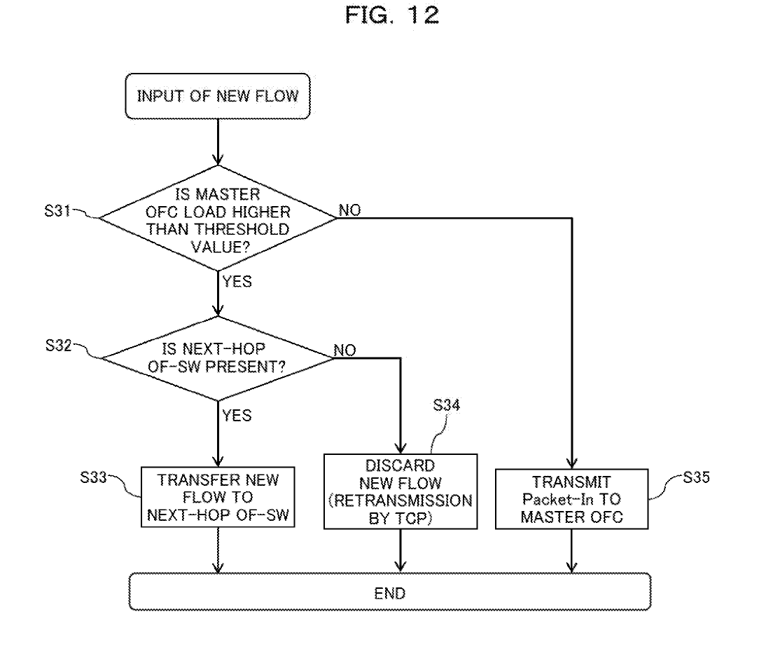

FIG. 12 is a flowchart illustrating an example of the operation of an OF-SW 4 (for example, the OF-SW 4-1).

When a packet of a new first flow is input to the OF-SW 4-1, the OF-SW 4-1 may check whether the OFC load information (for example, CPU utilization) of the master OFC 31-1 is higher than a threshold value through the use of the flow transfer determiner 43 (Process S31).

When the OFC load information of the master OFC 31-1 is not higher than the threshold value (NO in Process S31), the OF-SW 4-1 may transmit a packet-in to the distributed controller 3 (the master OFC 31-1) (Process S35, reference sign M12 in FIG. 10).

When the packet-in is received from the OF-SW 4-1, the master OFC 31-1 may perform calculating of the first flow and setting of a path of the first flow in cooperation with the other master OFCs 31-2 and 31-3, similarly to the case illustrated in FIG.

For example, the master OFCs 31-1, 31-2, and 31-3 that manage the OF-SWs may transmit a flow modification message to the OF-SWs 4-1, 4-3, and 4-4 (see reference sign M13 in FIG. 10).

In response to the flow modification message, a “rule” for the packet of the first flow is registered in the flow tables 44 of the OF-SW 4-1, 4-3, and 4-4. Thereafter, the packet of the first flow transmitted from the host 5-1 to the host 5-2 is transferred to the host 5-2 through the path routed through the OF-SWs 4-1, 4-3, and 4-4 (see the solid arrow M14 in FIG. 10).

On the other hand, when the OFC load information of the master OFC 31-1 is higher than the threshold value (YES in Process S31 in FIG. 12), the flow transfer determiner 43 of the OF-SW 4-1 may check whether a next-hop OF-SW 4 connected to the output port thereof is present (Process S32).

For example, the load information of the master OFC 31-1 may be higher than the threshold value in order to process the packet-in for the first flow. In this case, the flow transfer determiner 43 of the OF-SW 4-1 may check whether a next-hop OF-SW 4 is present based on the next-hop OF-SW information.

When it is checked that a next-hop OF-SW 4 is present (YES in Process S32 in FIG. 12), the OF-SW 4-1 may transfer an input packet of a new second flow to the next-hop OF-SW 4 without transmitting a packet-in to the master OFC 31-1 (Process S33).

In the examples illustrated in FIGS. 10 and 11, since the OF-SWs 4-3 and 4-2 are connected to the output ports P2 and P3 of the OF-SW 4-1, respectively, the determination result of Process S32 in FIG. 12 is YES.

Accordingly, the OF-SW 4-1 may transfer the input packet of the second flow to any one of the OF-SWs 4-3 and 4-2 without transmitting a packet-in to the master OFC 31-1. In FIG. 10, the input packet of the second flow is transferred to the OF-SW 4-3 via the output port P2 as a non-restrictive example (see reference sign M21).

When it is determined in Process S32 of FIG. 12 that a next-hop OF-SW 4 is not present (NO in Process S32), the OF-SW 4 may discard the input packets of the new flows (which may be any one of the first and second flows) (Process S34).

A case in which a next-hop OF-SW 4 is not present may include a case in which a packet transfer destination candidate of the new flow is the “host” (which is the same for the following description). The discarded packet may be retransmitted from the host 5-1 which is a packet transmission source of the new flow, for example, by a retransmission process by the TCP.

The OF-SW 4-3 having received the packet of the new second flow from the OF-SW 4-1 may operate as illustrated in the flowchart of FIG. 12, similarly to the OF-SW 4-1.

For example, when the OFC load information of the master OFC 31-2 is not higher than the threshold value (NO in Process S31 of FIG. 12), the OF-SW 4-3 transmits a packet-in to the master OFC 31-2 (Process S35, reference sign M22 in FIG. 10).

When a packet-in is received from the OF-SW 4-2, the master OFC 31-2 performs calculating of the path of the second flow and setting of the path of the second flow in cooperation with the other master OFCs 31-1 and 31-3.

For example, the master OFCs 31-1 to 31-3 that manage the OF-SWs transmit the flow modification message to the OF-SWs 4-1, 4-3, and 4-4 (see reference sign M23 in FIG. 10).

By the flow modification message, a “rule” for the packet of the second flow is registered in the flow tables 44 of the OF-SWs 4-1, 4-3, and 4-4. Thereafter, the packet of the second flow transmitted from the host 5-1 to the host 5-2 is transferred to the host 5-2 through the path routed through the OF-SWs 4-1, 4-3, and 4-4 (see the dotted arrow M24 in FIG. 10).

When the OFC load information of the master OFC 31-2 is higher than the threshold value and a next-hop OF-SW 4 is present, the OF-SW 4-3 may additionally transfer the packet of the new flow transferred from the OF-SW 4-1 to the next-hop OF-SW 4.

As described above, in a high-load state in which the load of the master OFC 31 is higher than the threshold value, each OF-SW 4 transfers the input packet to the next-hop OF-SW 4 without transmitting a packet-in for the input packet of the new flow to the master OFC 31.

Accordingly, it is possible to suppress a bias of loads due to concentration of the loads on a specific OFC 31. In other words, it is possible to reliably achieve load distribution to the OFCs 31. As a result, it is possible to stably operate the distributed controller 3.

### Second Example

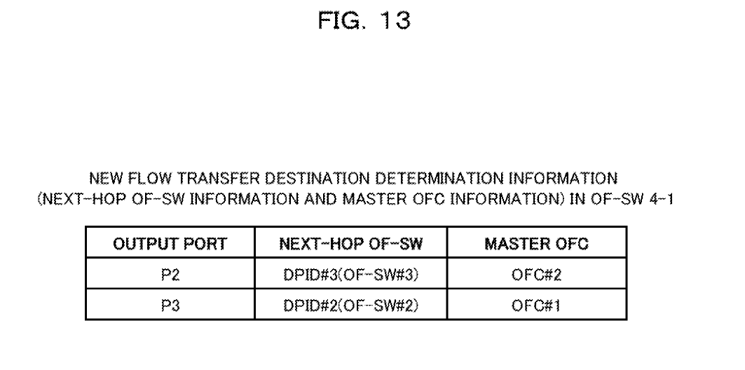

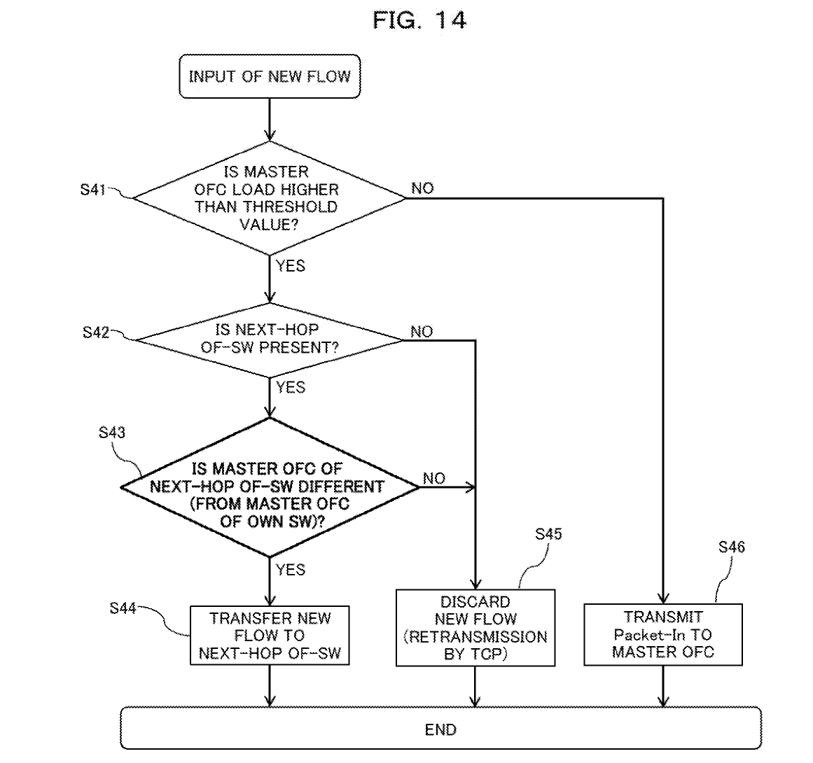

A processing example relevant to a second example when a packet of a new flow is input to an OF-SW 4 will be described below with reference to FIGS. 13 and 14.

In the first example, there is a possibility that the OF-SW 4 being managed by the same master OFC 31 as the master OFC 31 that manages an OF-SW 4 of a transfer source will be selected as an OF-SW 4 of a transfer destination of an input packet of a new flow.

For example, in FIG. 10, the OF-SW 4-1 can select the OF-SW 4-2 connected to the output port P3 thereof for the transfer destination of an input packet of a new flow. Here, the master OFC 31-1 of the OF-SW 4-2 is also the master OFC 31-1 of the OF-SW 4-1 of the transfer source.

Accordingly, even when the input packet of the new flow is transferred from the OF-SW 4-1 of which the management source is the same master OFC 31-1 to the OF-SW 4-2, there is a possibility that the loads will not be distributed to the OFCs 31.

Therefore, in the second example, the OF-SW 4 of the transfer source of the packet of the new flow can select the OF-SW 4 being managed by a master OFC 31 other than the master OFC 31 managing the OF-SWs 4 of the transfer destination as the transfer destination of the packet.

Based on the master OFC information of the next-hop OF-SW 4, it can be determined whether the master OFC 31 of the OF-SW 4 as the transfer source and the master OFC 31 of the next-hop OF-SW 4 as a transfer destination candidate are the same.

FIG. 13 illustrates an example of the next-hop OF-SW information and the master OFC information in the case illustrated in FIG. 10. The information illustrated in FIG. 13 is a second example of the “new flow transfer destination determination information.” In other words, the “new flow transfer destination determination information” may include the next-hop OF-SW information and the master OFC information as information elements.

The next-hop OF-SW information may be expressed by the DPID of the next-hop OF-SW 4, similarly to the example illustrated in FIG. 11. The master OFC information may include the identification information of the master OFC 31-2 of the next-hop OF-SW 4-3 and the identification information of the master OFC 31-1 of the next-hop OF-SW 4-2.

For example, the flow transfer determiner 43 of the OF-SW 4-1 refers to the new flow transfer destination determination information illustrated in FIG. 13. By this reference, the OF-SW 4-1 can recognize that the master OFCs of the OF-SWs 4-3 and 4-2 connected to the output ports P2 and P3 of the OF-SW 4-1 are the OFCs 31-2 and 31-1, respectively.

Accordingly, the OF-SW 4-1 can select the next-hop OF-SW 4-3 being managed by the master OFC 31-2 other than the master OFC 31-1 of the OF-SW 4-1 as a transfer destination of an input packet of a new flow.

FIG. 14 is a flowchart illustrating an example of the operation of an OF-SW 4 according to the second example. Processes S41, S42, and S44 to S46 illustrated in FIG. 14 may be the same as Processes S31 to S35 illustrated in FIG. 12.

In the case illustrated in FIG. 10, when a next-hop OF-SW 4 as a transfer destination candidate of a packet of a new flow is present, the flow transfer determiner 43 of the OF-SW 4-1 determines that the determination result of Process S42 is YES.

Based on the determination result, the flow transfer determiner 43 may check whether an OF-SW 4 having an OFC 31 other than the master OFC 31-1 of the OF-SW 4-1 as a master OFC is present based on the master OFC information illustrated in FIG. 13 (Process S43).

When it is checked that an OF-SW 4 having the OFC 31 other than the master OFC 31-1 as a master OFC is present (YES in Process S43), the flow transfer determiner 43 may transfer the input packet of the new flow to the OF-SW 4 (Process S44).

In the examples illustrated in FIGS. 10 and 13, since the master OFC 31-2 of the OF-SW 4-3 among the next-hop OF-SWs 4-2 and 4-3 is different from the master OFC 31-1 of the OF-SW 4-1, the input packet of the new flow is transferred to the OF-SW 4-3.

When an OF-SW 4 having the OFC 31 other than the master OFC 31-1 as a master OFC is not present (NO in Process S43), the flow transfer determiner 43 may discard the input packet of the new flow (Process S45). The discarded packet may be retransmitted from the host 5-1 which is a packet transmission source of the new flow, for example, by a retransmission process by the TCP.

As described above, according to the second example, each OF-SW 4 selects the OF-SW 4 having an OFC 31 other than the master OFC 31 for the corresponding SW 4 as a master OFC for a transfer destination when transferring an input packet of a new flow to a next-hop OF-SW 4. Accordingly, it is possible to more reliably achieve load distribution to the OFCs 31 than in the first example.

### Third Example

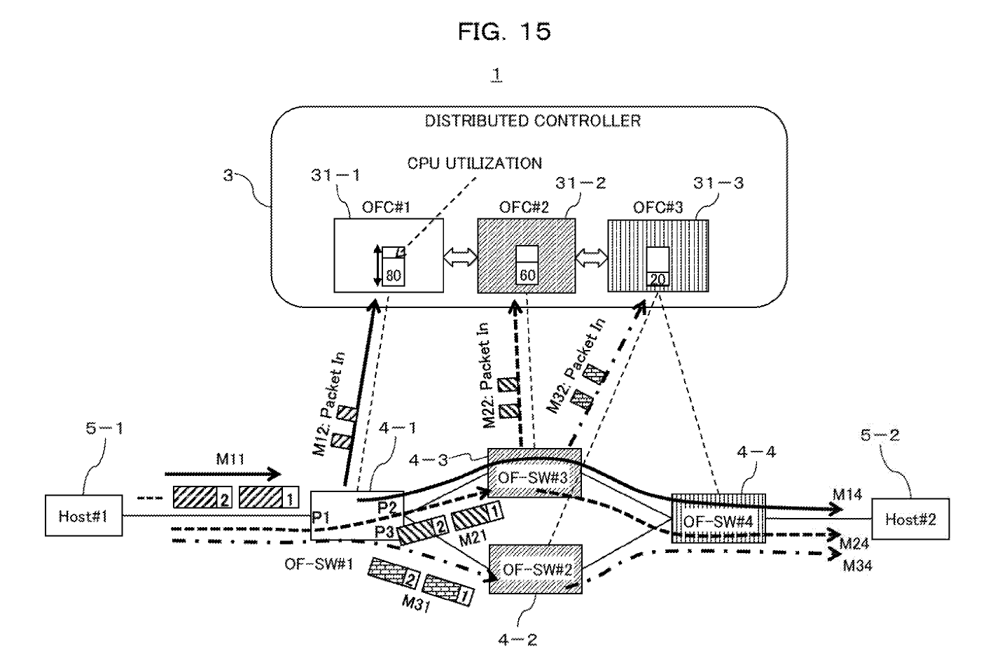

A processing example relevant to a third example when a packet of a new flow is input to an OF-SW 4 will be described below with reference to FIGS. 15 to 17.

In the third example, when plural next-hop OF-SWs 4 as a transfer destination candidate of a packet of a new flow are present, the OF-SW 4 may compare the loads of the master OFCs 31 of the plural OF-SWs 4. The OF-SW 4 may select the next-hop OF-SW 4 being managed by the OFC 31 with a relatively low load as a transfer destination.

FIG. 15 illustrates an example of a configuration of a communication system 1 according to the third example. In FIG. 15, connection relations among the host 5-1, the host 5-2, and the OF-SWs 4-1 to 4-4 are equal or similar to the connection relations illustrated in FIGS. 3 and 10.

In the example illustrated in FIG. 15, the master OFC that manages the OF-SW 4-1 is the OFC 31-1, the master OFC that manages the OF-SWs 4-2 and 4-4 is the OFC 31-3, and the master OFC that manages the OF-SW 4-3 is the OFC 31-2.

In the third example, it is assumed that packets of three new flows are input to the OF-SW 4-1 from the host 5-1, as a non-restrictive example.

In FIG. 15, it is assumed that the load of the master OFC 31-1 (for example, CPU utilization) is not higher than a threshold value (for example, 70%) at a time point at which a packet of a new first flow (see reference sign M11) is input to the OF-SW 4-1. In this case, the OF-SW 4-1 transmits a packet-in to the master OFC 31-1.

However, it is assumed that the load of the master OFC 31-1 is higher than the threshold value, for example, in order to process a packet-in for the first flow at a time point at which packet of a new second flow is input to the OF-SW 4-1.

In this case, for example, the OF-SW 4-1 transfers the input packet of the second flow to the next-hop OF-SW 4 without transmitting a packet-in for the second flow to the master OFC 31-1, similarly to the first or second example.

In the example illustrated in FIG. 15, the OF-SW 4-1 transfers the input packet of the second flow (see reference sign M21) to the next-hop OF-SW 4-3. When the load of the master OFC 31-2 is not higher than the threshold value, the OF-SW 4-3 transmits a packet-in for the second flow to the master OFC 31-2 (see reference sign M22).

It is assumed that the loads (for example, CPU utilization) of the OFCs 31-1 to 31-3 are 80%, 60%, and 20%, respectively, by the processing of the packet-ins for the first and second flows.

The state of CPU utilization=80% may be understood to be a state in which the load is higher than the threshold value 70%, and the state of CPU utilization=60% and the state of CPU utilization=20% may be understood to be states in which the load is not higher than the threshold value.

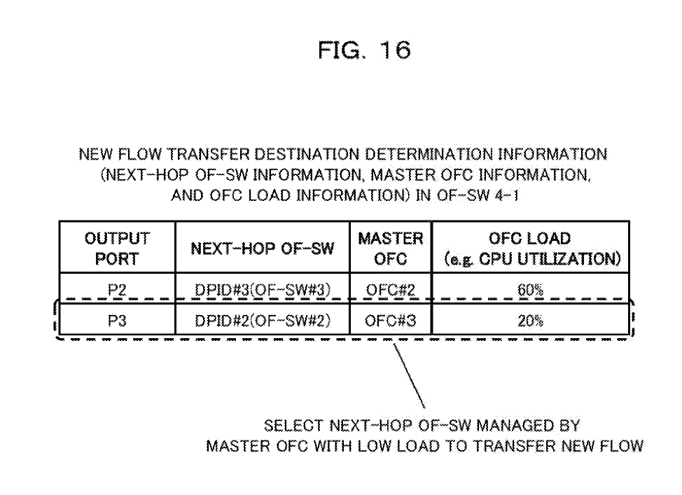

In this case, an example of information which is stored in the memory 412 (see FIG. 7) by the OF-SW 4-1 is illustrated in FIG. 16. The information illustrated in FIG. 16 is a third example of the “new flow transfer destination determination information.”

In other words, the new flow transfer destination determination information in the third example may include the next-hop OF-SW information, the master OFC information, and the OFC load information as information elements.

The next-hop OF-SW information may be the same as in the first example (for example, FIG. 11), and the master OFC information may be identification information of the master OFC 31 that manages the next-hop OF-SW 4, similarly to the second example (FIG. 13). The OFC load information may be the load information of the master OFC 31 that manages the next-hop OF-SW 4.

In the aforementioned load states of the OFCs 31-1 to 31-3, it is assumed that a packet of a new third flow is additionally input to the OF-SW 4-1.

In this case, similarly to the second example, the OF-SW 4 may check whether a next-hop OF-SW 4 having an OFC 31 other than the master OFC 31-1 of the OF-SW 4-1 as a master OFC is present based on the new flow transfer destination determination information illustrated in FIG. 16.

In the examples illustrated in FIGS. 15 and 16, two OF-SWs 4-3 and 4-2 having the OFCs 31-2 and 31-3 other than the OFC 31-1 as master OFCs are present. In other words, two OF-SWs 4-3 and 4-2 are present as the transfer destination candidates of the input packet of the new flow.

In this case, the OF-SW 4-1 may compare the OFC load information of the master OFCs 31-2 and 31-3 of the OF-SWs 4-3 and 4-2 as the transfer destination candidates and select and determine the OF-SW 4 being managed by the OFC 31 having the lower load as the transfer destination.

In the examples illustrated in FIGS. 15 and 16, since the load of the OFC 31-3 is lower than the load of the OFC 31-2, the OF-SW 4-1 may transfer the input packet of the new third flow to the OF-SW 4-2 being managed by the OFC 31-3 having the lower load (see reference sign M31 in FIG. 15).

In the OF-SW 4-2, the OFC load information of the master OFC 31-2 in the new flow transfer destination determination information is not higher than the threshold value in the examples illustrated in FIGS. 15 and 16. Accordingly, the OF-SW 4-1 may transmit a packet-in for the third flow to the master OFC 31-2 (see reference sign M32 in FIG. 15).

In this way, even when packets of three new flows are input to the OF-SW 4-1, the packet-ins for the flows are distributedly transmitted to the different OFCs 31-1 to 31-3 from the OF-SWs 4-1 to 4-3. Accordingly, it is possible to achieve load distribution to the OFCs 31-1 to 31-3.

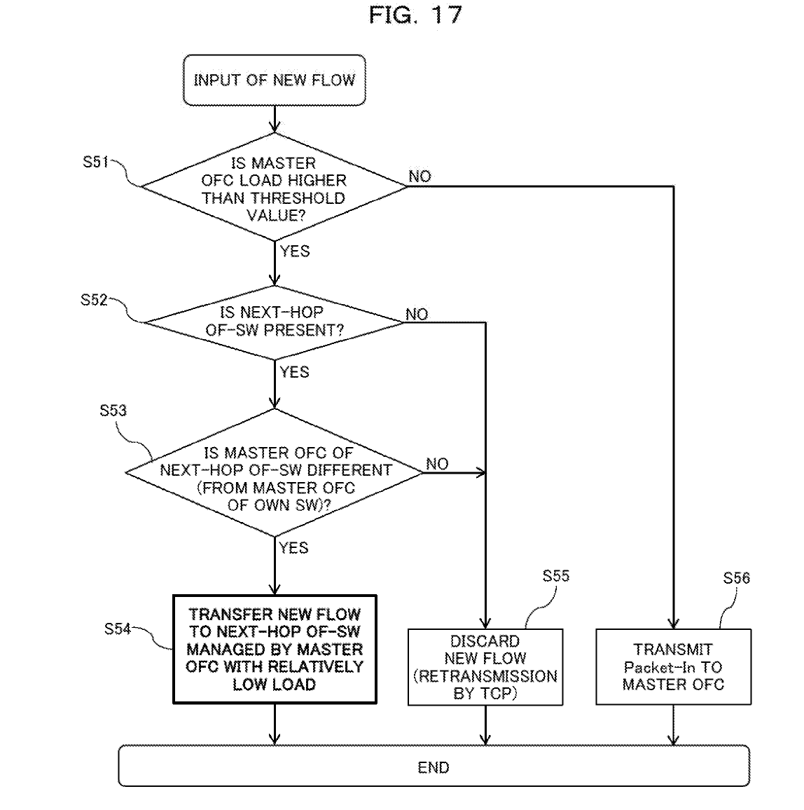

A processing example relevant to the third example of the OF-SW 4 which can realize the above-mentioned operation example is illustrated in the flowchart of FIG. 17. Processes S51 to S53, S55, and S56 illustrated in FIG. 17 may be the same as Processes S41 to S43, S45, and S46 illustrated in the second example (FIG. 14).

In the cases illustrated in FIGS. 15 and 16, the OF-SWs 4-3 and 4-2 having the OFCs 31-3 and 31-2 other than the master OFC 31-1 of the OF-SW 4-1 as a master OFC are present as the transfer destination candidates of a packet of a new flow. Accordingly, the flow transfer determiner 43 of the OF-SW 4-1 determines that the determination result of Process S53 is YES.

Based on the determination result, the flow transfer determiner 43 may select the next-hop OF-SW 4-2 having the OFC 31-3 with a relatively low load as a master OFC as the transfer destination based on the OFC load information illustrated in FIG. 16. Based on the determination result, the flow transfer determiner 43 may transfer an input packet of a new flow to the selected OF-SW 4-2 (Process S54).

As described above, according to the third example, when plural next-hop OF-SWs 4 are present as the transfer destination candidates of a packet of a new flow, the OF-SW 4 selects the OF-SW 4 being managed by the OFC 31 with a relatively low load among the master OFCs 31 for the transfer destination.

Accordingly, it is possible to more reliably achieve load distribution to the OFCs 31 in comparison with the first and second examples. Since the probability that a packet of a new flow is sequentially transferred to the OF-SWs 4 can be reduced, it may be possible to suppress a processing delay of a packet-in.

### Fourth Example

Similarly to the aforementioned third example, when plural next-hop OF-SWs 4 are present as the transfer destination candidate of an input packet of a new flow, the OF-SW 4 (for example, the flow transfer determiner 43) may distribute and transfer the packet of the new flow to the plural next-hop OF-SWs 4.

For example, in the cases illustrated in FIGS. 15 and 16, the OF-SW 4-1 may transfer more packets to the OF-SW 4-2 being managed by the OFC 31-3 having a low load than the OF-SW 4-3 being managed by the OFC 31-2 having a high load. In other words, the OF-SW 4-1 may control a transfer of an input signal of a new flow such that a transfer rate of a signal of the new flow in the OF-SW 4-2 is greater than that in the OF-SW 4-3.

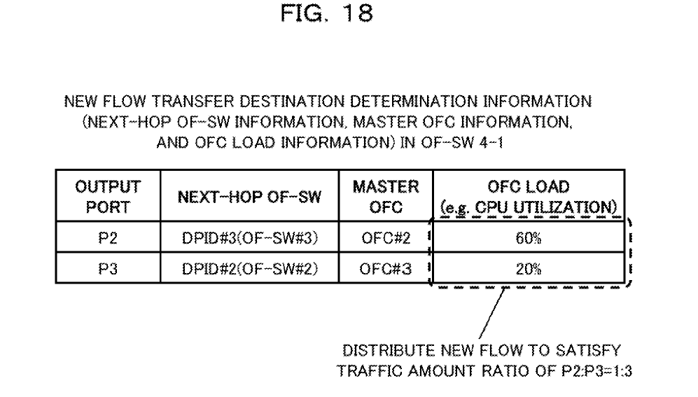

For example, as illustrated in FIG. 18, it is assumed that the load (for example, CPU utilization) of the OFC 31-2 is 60% and the load of the OFC 31-3 is 20%, similarly to FIG. 16.

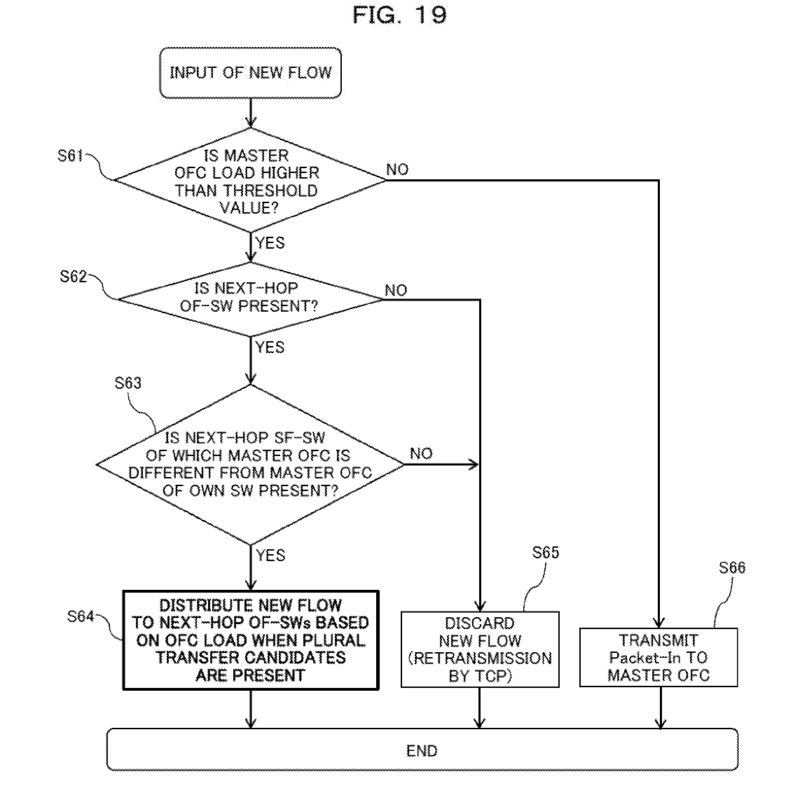

In this case, the OF-SW 4-1 may distribute and transfer the input packets of the new flows (that is, traffic) to the OF-SWs 4-3 and 4-2 so as to achieve a reverse ratio (1:3) of the loads of the OFCs 31-2 and 31-3 (Process S64 in FIG. 19).

Processes S61 to S63, S65, and S66 in FIG. 19 may be the same as Processes S51 to S53, S55, and S56 in the third example (FIG. 17).

According to the fourth example, since the traffic of the new flows is distributed and transferred depending on the load of the OFC 31 managing the next-hop OF-SW 4 as the transfer destination candidate, it is possible to achieve load distribution to the OFCs 31 and to suppress a processing delay of a packet-in.

### Fifth Example

In the first to fourth examples, all of the loads of the plural OFCs managing the plural OF-SWs 4 as the transfer destination candidates may be higher than the threshold value. In this case, there is a possibility that each OF-SW 4 will repeatedly transfer a packet of a new flow to the next-hop OF-SW 4 and a loop of packet transfer will be formed.

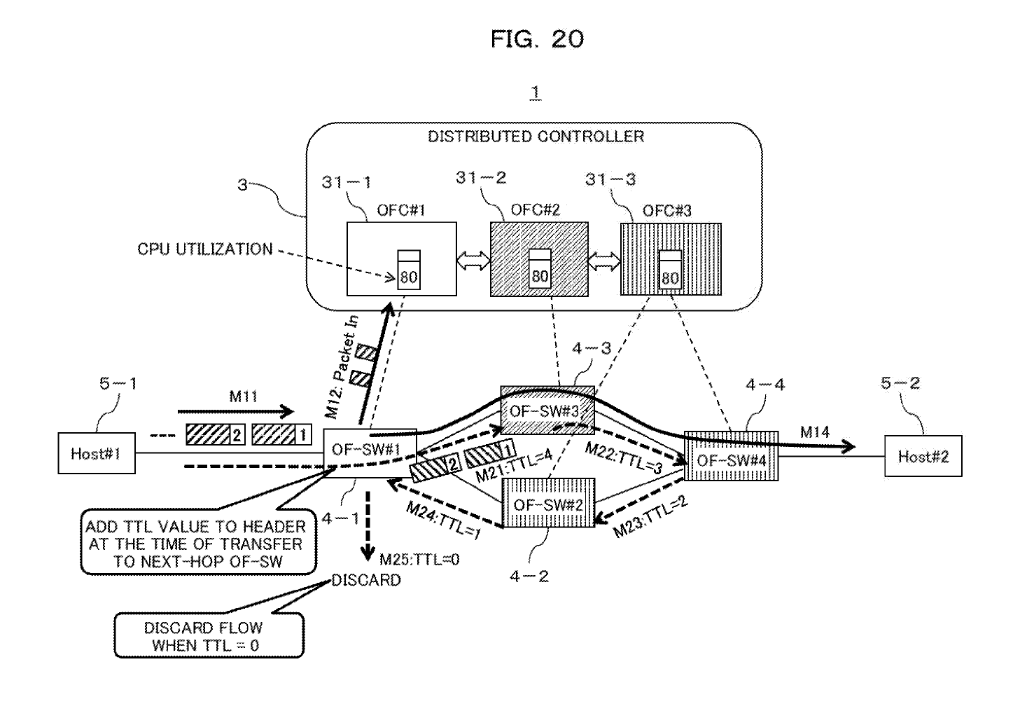

In the fifth example, an example in which the formation of the loop is suppressed will be described below with reference to FIGS. 20 to 22.

FIG. 20 is a diagram illustrating an example of a configuration of a communication system 1 according to the fifth example. In FIG. 20, the connection relations among the host 5-1, the host 5-2, and the OF-SWs 4-1 to 4-4 are equal or similar to the connection relations illustrated in FIG. 15.

The OF-SW 4 to which a packet of a new flow is input from the host 5-1 may set a time-to-live (TTL) value (for example, a positive integer) in a header field of a packet to be transferred at the time of transferring the packet to the next-hop OF-SW 4-3 in the same way as in the first to fourth examples.

Here, when a packet of a new flow is received, each OF-SW 4 other than a first-hop OF-SW 4-1 to which the packet of the new flow is input may decrement the TTL value of the header field by “−1.”

The packet of which the TTL value is “0” by decrement is not transferred anymore and may be discarded by the OF-SW 4 having detected that the TTL value is “0.”

For example, as illustrated in FIG. 20, it is assumed that the packet (see reference sign M21) which is transferred from the first-hop OF-SW 4-1 with the TTL value=4 set is transferred through the path routed through the OF-SWs 4-3, 4-4, and 4-2 and is returned to the OF-SW 4-1.

In this case, since the TTL values in the OF-SWs 4-3, 4-4, 4-2, and 4-1 are decremented by “−1” (see reference signs M22 to M25), the TTL value of the packet returned to the first-hop OF-SW 4-1 is “0.” Accordingly, the OF-SW 4-1 may discard the packet without additionally transferring the packet.

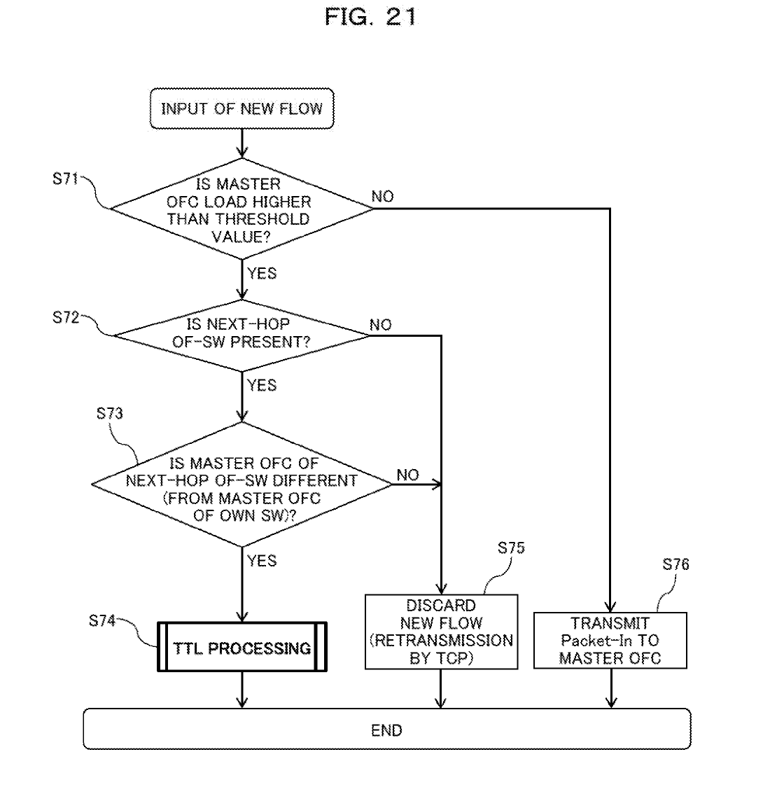

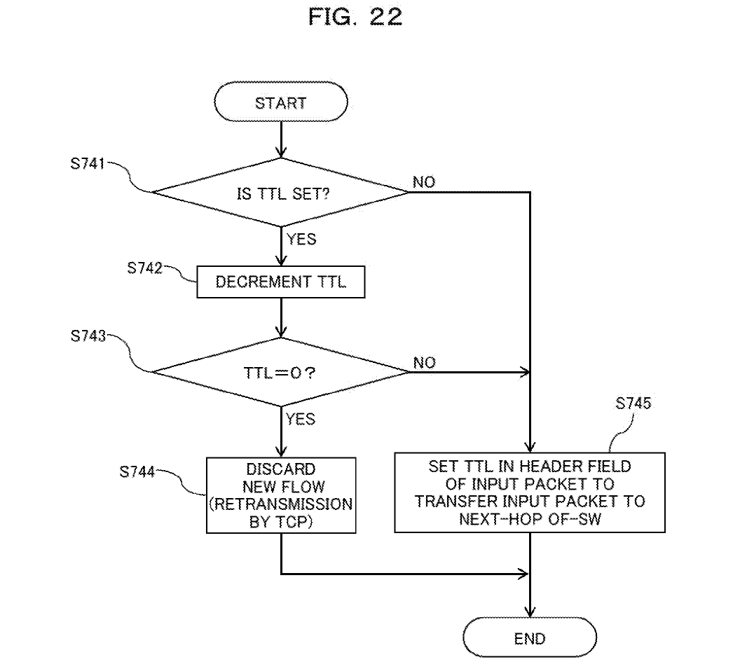

FIGS. 21 and 22 are flowcharts illustrating an example of the operation of the OF-SW 4 that can perform a process for avoiding the aforementioned loop transfer.

Processes S71 to S73, S75, and S76 illustrated in FIG. 21 may be the same as Processes S61 to S63, S65, and S66 illustrated in FIG. 19. In Process S74 illustrated in FIG. 21, the TTL value is processed (which may be abbreviated to “TTL processing” for descriptive purposes).

FIG. 22 is a flowchart illustrating an example of the TTL processing (S74). As illustrated in FIG. 22, the OF-SW 4 (the flow transfer determiner 43) may check whether a TTL value is set in the header field of a packet of a new flow to be transferred (Process S741).

When the TTL value is not set (NO in Process S741), the OF-SW 4 may set the TTL value in a packet field of the new flow to be transferred and transfer the packet of the new flow to the next-hop OF-SW 4 (Process S745). Process S745 may be understood to correspond to the processing by the first-hop OF-SW 4-1.

On the other hand, when the TTL value is set (YES in Process S741), the OF-SW 4 may decrement the TTL value by “−1” (Process 5742) and check whether the TTL value is “0” (Process S743).

When the decremented TTL value is not “0” (NO in Process S743), the OF-SW 4 may set the decremented TTL value in the header field of the packet of the new flow to be transferred and transfer the packet of the new flow to the next-hop OF-SW 4 (Process S745).

On the other hand, when the decremented TTL value is “0” (YES in Process S743), the OF-SW 4 may discard the input packet of the new flow without transferring the input packet to the next-hop OF-SW 4 (Process S744). The discarded packet may be retransmitted from packet transmission source of the new flow (the host 5-1 in the example illustrated in FIG. 20), for example, by a retransmission process by the TCP.

As described above, according to the fifth example, since occurrence of a packet transfer loop in a high-load state in which all the loads of the OFCs 31 are higher than the threshold value can be suppressed, it is possible to prevent waste of communication resources in the OF network 2.

### Sixth Example

In a sixth example, when all the loads of the OFCs 31 are higher than the threshold value, the OF-SW 4 may buffer an input packet of a new flow in the memory 412. The OF-SW 4 may monitor the load of an OFC 31 other than the master OFC 31 for the corresponding SW 4, and may transfer the buffered packet to the next-hop OF-SW 4 being managed by another OFC 31 when another OFC 31 of which the load is equal to or less than the threshold value is discovered.

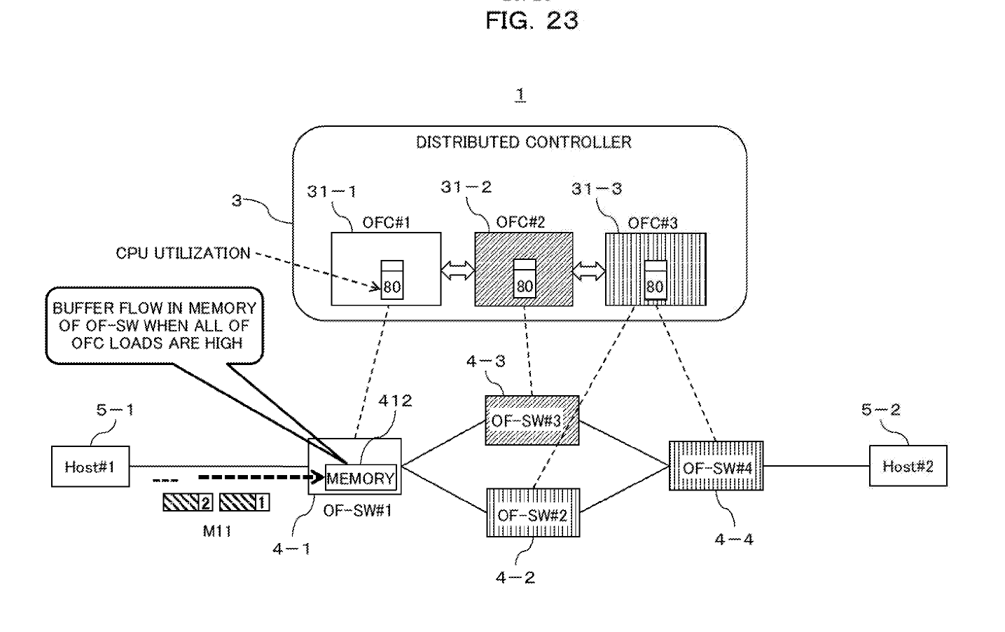

An example of an operation according to the sixth example will be described below with reference to FIGS. 23 to 27.

As illustrated in FIG. 23, it is assumed that a packet of a new flow for the OF-SW 4-1 is input to the OF-SW 4-1 from the host 5-1 (see reference sign M11 in FIG. 23).

The new flow may be understood to be a single flow input to the OF-SW 4-1 or may be understood to be one noticed flow among plural flows input to the OF-SW 4-1.

In response to an input of a packet of a new flow, the OF-SW 4-1 checks the load of the master OFC 31-1 and each of the loads of the master OFCs 31-3 and 31-2 of the next-hop OF-SWs 4-2 and 4-3 through the use of the flow transfer determiner 43.

Here, it is assumed that the loads (for example, CPU utilization) of the OFCs 31-1 to 31-3 are 80% and are higher than the threshold value (for example, 70%) as illustrated in FIG. 23. In this case, the flow transfer determiner 43 of the OF-SW 4-1 may buffer the input packet of the new flow in the memory 412.

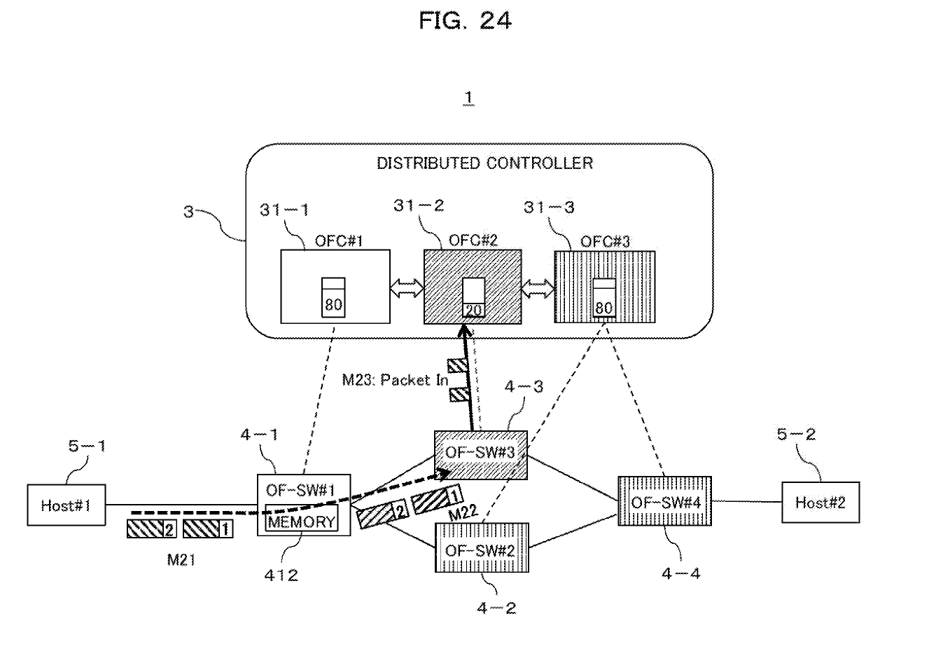

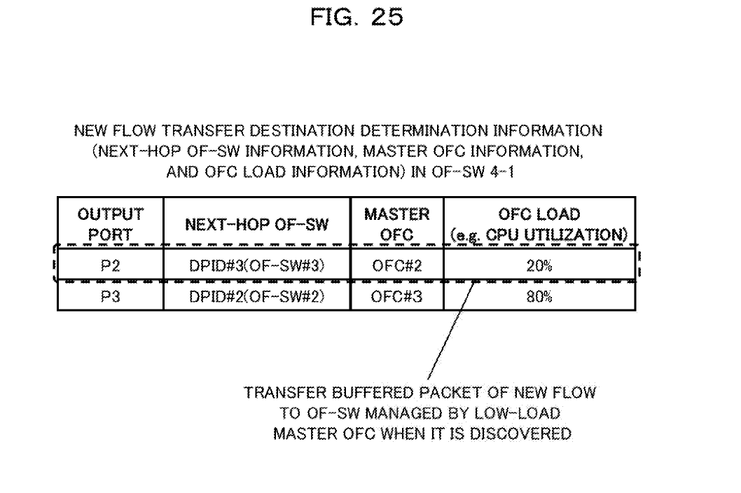

Thereafter, for example, as illustrated in FIGS. 24 and 25, it is assumed that the load of the OFC 31-2 decreases to, for example, 20% which is equal to or less than the threshold value. The flow transfer determiner 43 of the OF-SW 4-1 can detect that the load of the OFC 31-2 is equal to or less than the threshold value by referring to the OFC load information in the new flow transfer destination determination information illustrated in FIG. 25.

Accordingly, the flow transfer determiner 43 of the OF-SW 4-1 may read the input packet of the new flow buffered in the memory 412 from the memory 412 and transfer the read input packet to the next-hop OF-SW 4-2 having the OFC 31-2 as a master OFC (see reference sign M22 in FIG. 24).

In response to an input of the packet of the new flow transferred from the OF-SW 4-1, the OF-SW 4-2 may check the OFC load information of the master OFC 31-2 with reference to the new flow transfer destination determination information, for example, through the use of the flow transfer determiner 43.

In this case, since the load of the OFC 31-2 is 20% which is not higher than the threshold value, a packet-in for the input packet of the new flow transferred from the OF-SW 4-2 may be transferred to the OFC 31-2 (see reference sign M23 in FIG. 24).

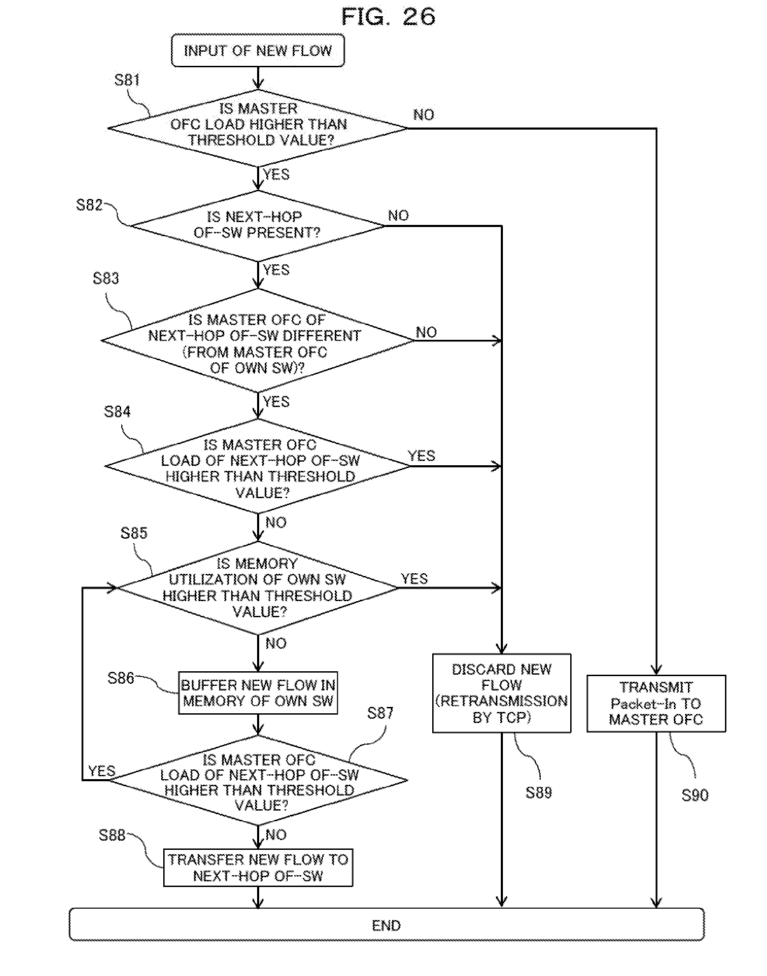

The aforementioned example of the operation is illustrated in the flowchart of FIG. 26. Processes S81 to S83, S89, and S90 illustrated in FIG. 26 may be the same as Processes S71 to S73, S75, and S76 illustrated in FIG. 21, respectively.

In Process S83, it is assumed that the flow transfer determiner 43 of the OF-SW 4 has checked that a next-hop OF-SW 4 having the OFC 31 other than the master OFC 31 for the corresponding SW 4 as a master OFC is present (YES in Process S83).

In this case, the flow transfer determiner 43 may additionally check whether the load of the master OFC 31 of the next-hop OF-SW 4 is higher than the threshold value in the new flow transfer destination determination information (Process S84).

When it is checked that the load of the master OFC 31 of the next-hop OF-SW 4 is higher than the threshold value (YES in Process S84), the flow transfer determiner 43 may discard the input packet of the new flow (Process S89). The discarded packet may be retransmitted from a packet transmission source of the new flow (for example, the host 5-1), for example, by a retransmission process by the TCP.

On the other hand, when the load of the master OFC 31 of the next-hop OF-SW 4 is not higher than the threshold value (NO in Process S84), the flow transfer determiner 43 may additionally check whether a used amount or utilization of the memory 412 of the own SW 4 is higher than the threshold value (Process S85).

When it is checked that the used amount or utilization of the memory 412 of the own SW 4 is higher than the threshold value (YES in Process S85), that is, when an empty memory capacity is insufficient, the flow transfer determiner 43 may discard the input packet of the new flow (Process S89). The discarded packet may be retransmitted from a packet transmission source of the new flow (for example, the host 5-1), for example, by a retransmission process by the TCP.

On the other hand, when the used amount or utilization of the memory 412 of the own SW 4 is not higher than the threshold value (NO in Process S85), that is, when an empty memory capacity is not insufficient, the flow transfer determiner 43 may buffer the input packet of the new flow in the memory 412 (Process S86).

Thereafter, the flow transfer determiner 43 may check whether the load of the master OFC 31 of the next-hop OF-SW 4 is higher than the threshold value in the new flow transfer destination determination information again (Process S87).

When it is checked that the load of the master OFC 31 of the next-hop OF-SW 4 is higher than the threshold value (YES in Process S87), the flow transfer determiner 43 may repeatedly perform Process S85 and the processes subsequent thereto.

On the other hand, when the load of the master OFC 31 of the next-hop OF-SW 4 is not higher than the threshold value (NO in Process S87), the flow transfer determiner 43 may read the packet buffered in the memory 412 and transfer the read packet to the next-hop OF-SW 4 (Process S88).

As described above, according to the sixth example, the OF-SW 4 buffers an input packet of a new flow in the memory 412 and waits for a transfer of the packet until an OFC 31 of which the load is not higher than the threshold value is discovered. Accordingly, it is possible to achieve load distribution to the OFCs 31 and to reduce a discard rate of a packet of a new flow.

According to the aforementioned technique, it is possible to suppress a bias of loads to a specific controller among plural controllers that manage plural network switches.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network switch comprising:
a load monitor configured to monitor a load of a first controller among a plurality of controllers, the network switch being managed by the first controller; and
a processor configured to process a signal of an input flow in accordance with a rule registered for the input flow, and to change, depending on the load monitored by the load monitor, a processing scheme for an input signal of an unknown flow for which the rule is unregistered.

2. The network switch according to claim 1, wherein the processor transmits the input signal of the unknown flow to a neighbor network switch when the load of the first controller is higher than a threshold value without inquiring of the first controller for the rule of the unknown flow.

3. The network switch according to claim 2, wherein the processor inquires of the first controller for the rule of the input signal of the unknown flow when the load of the first controller is not higher than the threshold value.

4. The network switch according to claim 2, wherein the processor selects the neighbor network switch being managed by a second controller other than the first controller among the plurality of controllers for a transfer destination of the input signal of the unknown flow.

5. The network switch according to claim 2, wherein the load monitor monitors loads of a plurality of second controllers that manage a plurality of neighbor network switches that are transfer destination candidates of the input signal of the unknown flow, and
the processor selects the neighbor network switch being managed by the second controller with a relatively low load among the plurality of second controllers for a transfer destination of the input signal of the unknown flow.

6. The network switch according to claim 2, wherein the load monitor monitors loads of a plurality of second controllers that manage a plurality of neighbor network switches that are transfer destination candidates of the input signal of the unknown flow, and
the processor controls a transfer of the input signal of the unknown flow to the neighbor network switch being managed by the second controller with a relatively low load among the plurality of second controllers such that a transfer rate of the signal of the unknown flow is higher than that to the neighbor network switch being managed by the second controller with a relatively high load among the plurality of second controllers.

7. The network switch according to claim 2, wherein the processor sets a time-to-live (TTL) value decremented for every reception by a plurality of network switches to the input signal of the unknown flow to be transferred to the neighbor network switch, and discards the input signal of the unknown flow of which the TTL value is 0 by the decrement.

8. The network switch according to claim 2, wherein the load monitor monitors loads of a plurality of second controllers that manage a plurality of neighbor network switches that are transfer destination candidates of the input signal of the unknown flow, and
the processor is configured to:
buffer the input signal of the unknown flow in a memory when all of the loads of the plurality of second controllers are higher than the threshold value; and
transfer, when a certain second controller of which the load is not higher than the threshold value is discovered, the buffered signal to a neighbor network switch being managed by the discovered second controller.

9. A network control apparatus comprising:
a load monitor configured to monitor loads of a plurality of controllers that manage a plurality of network switches; and
a processor configured to notify a first network switch of information indicative of a load of a first controller that manages the first network switch.

10. The network control apparatus according to claim 9, wherein the processor notifies the first network switch of information indicative of a load of a second controller that manages a second network switch being connected to the first network switch.

11. A network system comprising:
a plurality of network switches configured to process a signal of an input flow in accordance with a rule which is registered for the flow; and
a network control apparatus configured to manage the plurality of network switches with a plurality of controllers,
wherein the network control apparatus notifies one or more network switches being managed by the controllers of information indicative of a load of the controller that manages the one or more network switches, and
the network switch having received the information indicative of the load changes, based on the information indicative of the load, a processing scheme for an input signal of an unknown flow for which the rule is unregistered.
